(19) United States
(12) Patent Application Publication
(10) Pub. No.: US 2026/0064793 A1
(43) Pub. Date: Mar. 5, 2026

(54) SYSTEMS, METHODS, AND APPARATUSES FOR IDENTIFYING SIGNIFICANT WEBPAGE EVENTS AND TUNING WEB BROWSER HINTS

(71) Applicant: Snappi, Inc., Carlsbad, CA (US)

(72) Inventors: Peter J. Lepeska, Boston, MA (US); C. Jethro Lam, Clarksburg, MD (US); Eric Rosenthal, Boston, MA (US)

(21) Appl. No.: 19/382,805

(22) Filed: Nov. 7, 2025

Related U.S. Application Data
(63) Continuation of application No. PCT/US2024/054282, filed on Nov. 1, 2024.
(60) Provisional application No. 63/595,605, filed on Nov. 2, 2023.
(60) Provisional application No. 63/617,703, filed on Jan. 4, 2024.

(51) Int. Cl. G06F 16/957; G06F 11/34

(52) U.S. Cl. CPC G06F 16/9577; G06F 11/3419; G06F 11/3442; G06F 2201/86

(57) ABSTRACT

Webpage performance is optimized with techniques that identify essential resources needed for rendering significant events and optimizing hints for the essential resources.

### CROSS-REFERENCES TO RELATED APPLICATIONS

This application claims priority to and is a bypass continuation of International Patent Application No. PCT/US2024/054282, filed Nov. 1, 2024, and entitled “SYSTEMS, METHODS, AND APPARATUSES FOR IDENTIFYING SIGNIFICANT WEBPAGE EVENTS AND TUNING WEB BROWSER HINTS” (VS2466-WO-1).

International Patent Application No. PCT/US2024/054282 claims the benefit of Provisional Patent Application Ser. No.: U.S. 63/595,605, filed Nov. 2, 2023, and entitled “TUNING HINTS FOR IMPROVED WEB BROWSER PERFORMANCE” (VS2466-US-1); and U.S. 63/617,703, filed Jan. 4, 2024, and entitled “DISCOVERY OF REQUIRED SUB-RESOURCES OF A SIGNIFICANT EVENT IN A WEBPAGE RENDERING” (VS2495-US-1).

All of the foregoing patent applications are incorporated herein by reference in their entirety for all purposes.

### BACKGROUND

Webpages are made up of numerous resources, including images, scripts, stylesheets, fonts, and other media files, which browsers must fetch to render content fully. These resources vary widely in their importance and impact on the user experience. While some resources are essential for displaying the primary content (e.g., above-the-fold content, such as key images, main text, and layout styling), other elements are less critical. For example, images located further down the page, background scripts, or secondary styling may be non-essential for immediate functionality and visual presentation when the page first loads.

Fetching every resource simultaneously, regardless of its relevance to the initial display, can lead to inefficient use of bandwidth and increase load times. When non-essential resources compete for network bandwidth and processing power with high-priority elements, they create unnecessary delays in displaying primary content, causing the page to feel slower and less responsive. This can lead to a frustrating user experience, particularly on slower networks or devices with limited processing power, where every additional resource can further slow the loading process.

By selectively prioritizing only the resources essential for the initial render, such as main text and visible images, developers can minimize the amount of data the browser needs to process immediately, reducing the time it takes for users to see and interact with the content. Resources that don't impact the first visible area or immediate functionality, like images lower down the page, can be deferred or loaded asynchronously, ensuring that they don't consume valuable bandwidth or CPU resources during the critical first moments.

Hinting is a technique in web performance optimization and allows prioritizing resources that are needed for rendering events. Hints indicate which resources should be preloaded, prefetched, or prioritized based on their impact on the user experience and they help browsers make decisions about loading sequences, especially for resources that are essential for initial display and interactivity. Without hinting, browsers may load resources in a default, less optimal order, fetching non-essential elements that delay the rendering of visible content. Through hints, key resources can be loaded promptly, reducing perceived wait times and enhancing page responsiveness.

### SUMMARY

In some aspects, the techniques described herein relate to an apparatus including: a resource procurement circuit structured to interpret a set of resources; a resource identifier circuit structured to select a first subset of resources from the set of resources; a resource provisioning circuit structured to transmit the set of resources to an application, wherein the first subset of resources is transmitted to the application after a first delay; a resource monitoring circuit structured to: monitor a first execution of the application that uses the set of resources, and determine a first timing of an event during the first execution; a resource analysis circuit structured to determine, based at least in part on the first timing and the first delay, one or more blocking resources, in the set of resources, for the event; and an analysis provisioning circuit structured to transmit a message including an indicator that identifies the one or more blocking resources.

In some aspects, the techniques described herein relate to a method including: interpreting, via a resource procurement circuit, a set of resources; selecting, via a resource identifier circuit, a first subset of resources from the set of resources; transmitting, via a resource provisioning circuit, the set of resources to an application, wherein the first subset of resources is transmitted to the application after a first delay; monitoring, via resource monitoring circuit, a first execution of the application that uses the set of resources; determining, via resource monitoring circuit, a first timing of an event during the first execution; determining, via a resource analysis circuit and based at least in part on the first timing and the first delay, one or more blocking resources, in the set of resources, for the event; and transmitting, via an analysis provisioning circuit, a message including an indicator that identifies the one or more blocking resources.

In some aspects, the techniques described herein relate to a non-transitory computer-readable medium storing instructions that, when loaded into at least one processor, cause the at least one processor to: interpret a set of resources; select a first subset of resources from the set of resources; transmit the set of resources to an application, wherein the first subset of resources is transmitted to the application after a first delay; monitor a first execution of the application that uses the set of resources; determine a first timing of an event during the first execution; determine, based at least in part on the first timing and the first delay, one or more blocking resources, in the set of resources, for the event; and transmit a message including an indicator that identifies the one or more blocking resources.

In some aspects, the techniques described herein relate to an apparatus including: a resource procurement circuit structured to load a first set of resources for consumption by a first application; a resource provisioning circuit structured to provide the first set of resources for the first application; a resource monitoring circuit structured to monitor a first execution of the first application with the first set of resources; a timing circuit structured to determine a first timing of an event during the first execution; wherein: the resource procurement circuit is further structured to load a second set of resources and a third set of resources for consumption by the first application, wherein the second set of resources is a subset of the first set of resources, the third set of resources is a different subset of the first set of resources; the resource provisioning circuit is further structured to provide, at a first time, the second set of resources for the first application; the resource monitoring circuit is further structured to monitor a second execution of the first application with the second set of resources; the resource provisioning circuit is further structured to provide, at a second time, the third set of resources for the first application; the resource monitoring circuit is further structured to monitor a third execution of the first application with the third set of resources; the timing circuit is further structured to determine a second timing of the event during the second execution and the third execution; wherein the apparatus further includes: a resource analysis circuit structured to determine, from the second timing, that the third set of resources includes resources that are required for the event; and an analysis provisioning circuit structured to transmit a message including an indication that identifies the third set of resources as including the resources as being required for the event.

In some aspects, the techniques described herein relate to a method including: loading a first set of resources for consumption by a first application; providing the first set of resources for the first application; monitoring a first execution of the first application with the first set of resources; determining a first timing of an event during the first execution; loading a second set of resources and a third set of resources for consumption by the first application, wherein the second set of resources is a subset of the first set of resources, the third set of resources is a different subset of the first set of resources; providing, at a first time, the second set of resources for the first application; monitoring a second execution of the first application with the second set of resources; providing, at a second time, the third set of resources for the first application; monitoring a third execution of the first application with the third set of resources; determining a second timing of the event during the second execution and the third execution; and determining, from the second timing, that the third set of resources includes resources that are required for the event.

In some aspects, the techniques described herein relate to an apparatus including: a resource procurement circuit structured to load a first set of resources; a selection circuit structured to select, from the first set of resources, a second set of resources and a third set of resources, wherein the second set of resources is a subset of the first set of resources, the third set of resources is a different subset of the first set of resources; a resource provisioning circuit structured to provide, at a first time, the second set of resources for a first application; a resource monitoring circuit structured to monitor a first execution of the first application with the second set of resources; wherein the resource provisioning circuit is further structured to provide, at a second time, the third set of resources for the first application; wherein the resource monitoring circuit is further structured to monitor a second execution of the first application with the third set of resources; wherein the apparatus further includes: a timing circuit structured to determine a timing of an event during the first execution and the second execution; and a resource analysis circuit structured to determine, based on the first time, the second time, and the timing, that the third set of resources includes resources that are required for the event.

In some aspects, the techniques described herein relate to a method including: loading a first set of resources; selecting, from the first set of resources, a second set of resources and a third set of resources, wherein the second set of resources is a subset of the first set of resources, the third set of resources is a different subset of the first set of resources; providing, at a first time, the second set of resources for a first application; monitoring a first execution of the first application with the second set of resources; providing, at a second time, the third set of resources for the first application; monitoring a second execution of the first application with the third set of resources; determining a timing of an event during the first execution and the second execution; and determining, based on the first time, the second time, and the timing, that the third set of resources includes resources that are required for the event.

In some aspects, the techniques described herein relate to an apparatus including: a resource procurement circuit structured to interpret a set of resources; a resource identifier circuit structured to select, from the set of resources, a first subset of resources; a resource provisioning circuit structured to transmit the set of resources to an application, wherein the first subset of resources are transmitted after a first delay; a resource monitoring circuit structured to: monitor a first execution of the application; and monitor one or more paint events for one or more areas of a page; a resource analysis circuit structured to: determine a timeline of the one or more paint events; and determine, based on the timeline and the first delay, that the first subset of resources includes one or more blocking resources for the event; and an analysis provisioning circuit structured to transmit a message including an indicator that identifies the one or more blocking resources.

In some aspects, the techniques described herein relate to a method including: interpreting, via a resource procurement circuit, a set of resources; selecting, via a resource identifier circuit, from the set of resources, a first subset of resources; transmitting, via a resource provisioning circuit, the set of resources to an application, wherein the first subset of resources are transmitted after a first delay; monitoring, via a resource monitoring circuit, a first execution of the application; monitoring, via the resource monitoring circuit, one or more paint events for one or more areas of a page; determining, via a resource analysis circuit, a timeline of the one or more paint events; and determining, via the resource analysis circuit and based on the timeline and the first delay, that the first subset of resources includes one or more blocking resources for the event; and transmitting, via an analysis provisioning circuit, a message including an indicator that identifies the one or more blocking resources.

In some aspects, the techniques described herein relate to an apparatus including: a hint procurement circuit structured to interpret hint data defining a plurality of hints structured to facilitate loading of a webpage; a combination circuit structured to generate a plurality of hint combinations from the plurality of hints; an auto-tuning circuit structured to: load, for each of the plurality of hint combinations, the webpage using the hint combination; determine, for each loading of the webpage, a timing for an event associated with the loading for the webpage; and generate, based at least in part on the timings, performance data for the plurality of hint combinations; and a performance provisioning circuit structured to transmit the performance data.

In some aspects, the techniques described herein relate to a method including: interpreting, via a hint procurement circuit, hint data defining a plurality of hints structured to facilitate loading of a webpage; generating, via a combination circuit, a plurality of hint combinations from the plurality of hints; loading, via an auto-tuning circuit, for each of the plurality of hint combinations, the webpage using the hint combination; determining, for each loading of the webpage and via the auto-tuning circuit, a timing for an event associated with the loading for the webpage; generating, via the auto-tuning circuit and based at least in part on the timings, performance data for the plurality of hint combinations; and transmitting, via a performance provisioning circuit, the performance data.

In some aspects, the techniques described herein relate to a non-transitory computer-readable medium storing instructions that, when loaded into at least one processor, cause the at least one processor to: interpret hint data defining a plurality of hints structured to facilitate loading of a webpage; generate a plurality of hint combinations from the plurality of hints; load, for each of the plurality of hint combinations, the webpage using the hint combination; determine, for each loading of the webpage, a timing for an event associated with the loading for the webpage; generate, based at least in part on the timings, performance data for the plurality of hint combinations; and transmit the performance data.

In some aspects, the techniques described herein relate to an apparatus including: a hint procurement circuit structured to interpret hint data defining a plurality of hints structured to facilitate loading of a webpage; a combination circuit structured to generate a plurality of hint combinations from the plurality of hints; an auto-tuning circuit structured to: load, for each of the plurality of hint combinations, the webpage using the hint combination; determine, for each loading of the webpage, a timing for an event associated with the loading for the webpage; and select a hint combination from the plurality of hint combinations based at least in part on the timings; and a recommendation provisioning circuit structured to transmit the selected hint combination.

In some aspects, the techniques described herein relate to a method including: interpreting, via a hint procurement circuit, hint data defining a plurality of hints structured to facilitate loading of a webpage; generating, via a combination circuit, a plurality of hint combinations from the plurality of hints; loading, for each of the plurality of hint combinations and via an auto-tuning circuit, the webpage using the hint combination; determining, for each loading of the webpage and via the auto-tuning circuit, a timing for an event associated with the loading for the webpage; selecting, via the auto-tuning circuit, a hint combination from the plurality of hint combinations based at least in part on the timings; and transmitting, via a recommendation provisioning circuit, the selected hint combination.

In some aspects, the techniques described herein relate to a non-transitory computer-readable medium storing instructions that, when loaded into at least one processors, cause the at least one processor to: interpret hint data defining a plurality of hints structured to facilitate loading of a webpage; generate a plurality of hint combinations from the plurality of hints; load, for each of the plurality of hint combinations, the webpage using the hint combination; determine, for each loading of the webpage, a timing for an event associated with the loading for the webpage; select a hint combination from the plurality of hint combinations based at least in part on the timings; and transmit the selected hint combination.

In some aspects, the techniques described herein relate to an apparatus including: a resource procurement circuit structured to interpret a set of resources for a webpage; a resource identifier circuit structured to select a first subset of resources from the set of resources; a resource provisioning circuit structured to transmit the set of resources to a webpage browser, wherein the first subset of resources is transmitted to the webpage browser after a first delay; a resource monitoring circuit structured to: monitor a first execution of the webpage browser that uses the set of resources to load the webpage, and determine a first timing of an event during the first execution; a resource analysis circuit structured to determine, based at least in part on the first timing and the first delay, one or more blocking resources, in the set of resources, for the event; a hint procurement circuit structured to interpret hint data defining a plurality of hints structured to facilitate prefetching of the one or more blocking resources as part of loading of the webpage; a combination circuit structured to generate a plurality of hint combinations from the plurality of hints; an auto-tuning circuit structured to: load, for each of the plurality of hint combinations, the webpage using the webpage browser and the hint combination; determine, for each loading of the webpage, a timing for an event associated with the loading for the webpage; generate, based at least in part on the timings, performance data for the plurality of hint combinations; and select a hint combination from the plurality of hint combinations based at least in part on the timings; and a recommendation provisioning circuit structured to transmit the selected hint combination.

In some aspects, the techniques described herein relate to a method including: interpreting, via a resource procurement circuit, a set of resources for a webpage; selecting, via a resource identifier circuit, a first subset of resources from the set of resources; transmitting, via a resource provisioning circuit, the set of resources to a webpage browser, wherein the first subset of resources is transmitted to the webpage browser after a first delay; monitoring, via a resource monitoring circuit, a first execution of the webpage browser that uses the set of resources to load the webpage; determining, via the resource monitoring circuit, a first timing of an event during the first execution; determining, via a resource analysis circuit and based at least in part on the first timing and the first delay, one or more blocking resources, in the set of resources, for the event; interpreting, via hint procurement circuit, hint data defining a plurality of hints structured to facilitate prefetching of the one or more blocking resources as part of loading of the webpage; generating, via a combination circuit, a plurality of hint combinations from the plurality of hints; loading, for each of the plurality of hint combinations via an auto-tuning circuit, the webpage using the webpage browser and the hint combination; determining, for each loading of the webpage via the via an auto-tuning circuit, a timing for an event associated with the loading for the webpage; generating, via the auto-tuning circuit and based at least in part on the timings, performance data for the plurality of hint combinations; selecting, via the via an auto-tuning circuit, a hint combination from the plurality of hint combinations based at least in part on the timings; and transmitting, via a recommendation provisioning circuit, the selected hint combination.

In some aspects, the techniques described herein relate to a non-transitory computer-readable medium storing instructions that, when loaded into at least one processor, causes the at least one processor to: interpret a set of resources for a webpage; select a first subset of resources from the set of resources; transmit the set of resources to a webpage browser, wherein the first subset of resources is transmitted to the webpage browser after a first delay; monitor a first execution of the webpage browser that uses the set of resources to load the webpage; determine a first timing of an event during the first execution; determine, based at least in part on the first timing and the first delay, one or more blocking resources, in the set of resources, for the event; interpret hint data defining a plurality of hints structured to facilitate prefetching of the one or more blocking resources as part of loading of the webpage; generate a plurality of hint combinations from the plurality of hints; load, for each of the plurality of hint combinations, the webpage using the webpage browser and the hint combination; determine, for each loading of the webpage, a timing for an event associated with the loading for the webpage; generate, based at least in part on the timings, performance data for the plurality of hint combinations; select a hint combination from the plurality of hint combinations based at least in part on the timings; and transmit the selected hint combination.

In some aspects, the techniques described herein relate to a system including: a snappi-event identifier circuit structured to interpret a set of resources for a webpage and determine one or more blocking resources; a hint conducting circuit structured to: interpret data defining a plurality of hints structured to facilitate prefetching of the one or more blocking resources as part of loading webpage; and generate a recommended hint set for one or more of the plurality of hints; and a recommendation provisioning circuit structured to transmit the recommended hint set.

In some aspects, the techniques described herein relate to a method including: interpreting, via a snappi-event identifier circuit, a set of resources for a webpage; determining, via the snappi-event identifier circuit, one or more blocking resources; interpreting, via a hint conducting circuit, data defining a plurality of hints structured to facilitate prefetching of the one or more blocking resources as part of loading webpage; generating, via the hint conducting circuit, a recommended hint set for one or more of the plurality of hints; and transmitting, via a recommendation provisioning circuit, the recommended hint set.

In some aspects, the techniques described herein relate to a non-transitory computer-readable medium storing instructions that, when loaded into at least one processor, cause the at least one processor to: interpret a set of resources for a webpage and determine one or more blocking resources; interpret data defining a plurality of hints structured to facilitate prefetching of the one or more blocking resources as part of loading webpage; generate a recommended hint set for one or more of the plurality of hints; and transmit the recommended hint set.

In some aspects, the techniques described herein relate to a method including: visiting a webpage with a web browser; observing a first timing of a page event for the webpage; recording a superset of resources fetched as part of a rendering of the webpage occurring prior to the page event; visiting the webpage a second time with a web browser that introduces a delay prior to the fetching of one of the superset of resources, wherein the delay is of an amount that is greater than the timing of the page event; observing a second timing of the page event after the delay; and determining, based in part on the second timing and the amount of the delay, that the one of the superset of resources is blocking for the page event.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts aspects of a system for identifying blocking resources and tuning web browser hints.

FIG. 2 depicts an example of a logical data flow for elements of the system.

FIG. 3 depicts an example time sequence diagram.

FIG. 4 depicts aspects of an example hinting service.

FIG. 5 depicts an example waterfall diagram.

FIG. 6 depicts aspects of an apparatus for identifying blocking resources.

FIG. 7 depicts aspects of another embodiment of an apparatus for identifying blocking resources.

FIG. 8 depicts aspects of a method for identifying blocking resources.

FIG. 9 depicts aspects of another method for identifying blocking resources.

FIG. 10 depicts aspects of an apparatus for identifying blocking resources.

FIG. 11 depicts aspects of another method for identifying blocking resources.

FIG. 12 depicts aspects of another apparatus for identifying blocking resources.

FIG. 13 depicts aspects of another method for identifying blocking resources.

FIG. 14 depicts aspects of another apparatus for identifying blocking resources.

FIG. 15 depicts aspects of another apparatus for identifying blocking resources.

FIG. 16 depicts aspects of another method for identifying blocking resources.

FIG. 17 depicts aspects of an apparatus for tuning hints for a webpage.

FIG. 18 depicts aspects of an example embodiment of an apparatus structured to generate a hint priority tag.

FIG. 19 depicts aspects of an example embodiment of an apparatus structured to inject the hint priority tag into the webpage.

FIG. 20 depicts aspects of an example method.

FIG. 21 depicts aspects of a method.

FIG. 22 depicts aspects of a method.

FIG. 23 depicts aspects of an example apparatus.

FIG. 24 depicts aspects of an example method.

FIG. 25 depicts aspects of an example apparatus that combines aspects of identifying essential resources and auto-tuning hints.

FIG. 26 depicts aspects of an example system that combines aspects of identifying essential resources and auto-tuning hints.

### DETAILED DESCRIPTION

Disclosed herein are embodiments and applications that optimize webpage performance by introducing a novel technique for identifying which resources are necessary for rendering significant event(s). The techniques address the inefficiencies that occur when browsers fetch and process resources that are not essential to the timely completion of critical events during rendering of a webpage.

Determining essential resources (herein also referred to as blocking resources) for a webpage is challenging because of the complex interplay between various elements and the browser's rendering process. Webpages are composed of numerous resources—such as images, CSS, Javascript files, fonts, and multimedia each of which can impact how and when specific parts of a page are displayed. In many instances, resources may include complex dependency chains. For example, JavaScript may rely on CSS for styling elements, or an image might be part of a script-driven animation. These dependencies mean that removing or deprioritizing a seemingly non-critical resource can impact other elements or delay rendering altogether, leading to potential disruptions in how or when content appears. In many instances, webpages may include dynamic content loading. Many webpages rely on JavaScript to load additional resources dynamically, often based on user interactions. Resources loaded after the initial render, such as content loaded via AJAX or API calls, can still affect the page's layout and functionality. In many instances, significant event timing may depend on user-specific content. Resources deemed critical may vary depending on the user's device, screen size, or geographic location. For example, high-resolution images may be essential on a desktop but non-essential on mobile. This variability means that determining essential resources requires careful consideration.

Existing methods for identifying essential resources are often inadequate due to the complexity and variability of modern webpages. Approaches like manually selecting resources based on intuition, trial-and-error, or relying solely on standard metrics fail to account for the nuanced dependencies between resources and the specific needs of diverse user contexts. These methods may overlook hidden dependencies, such as JavaScript functions that rely on particular styles and/or images, leading to unintended side effects when non-essential resources are deprioritized or removed.

Additionally, existing approaches lack the precision needed to differentiate between resources that are critical for initial rendering and those that can be deferred. This lack of systematic identification often results in either over-fetching, where too many resources are loaded at once, causing unnecessary bandwidth use and slower load times, or under-fetching, where key resources are missed, leading to broken or incomplete page elements.

Accordingly, disclosed herein are systems and methods for improved identification of essential resources for significant events. Embodiments include a process where multiple instances of the webpage are rendered, with each instance selectively delaying the loading of one or more specific resources. By comparing the performance of these instances, the system can observe whether delaying a particular resource has any impact on the timing of the significant event (herein also referred to as a key event).

If the delay of a resource does not affect the timing of the significant event, it is inferred that the resource is not required for the rendering process, and the resource can be safely deprioritized. On the other hand, if the event is delayed as a result of postponing the resource, this indicates that the resource is needed and should be prioritized during the page load. This method provides a clear, data-driven approach to distinguish between essential and non-essential resources for different events associated with rendering a webpage.

The discovery technique described herein not only improves the accuracy of resource management but also significantly enhances overall webpage performance by optimizing the order in which resources are fetched. Essential resources can be prioritized for preloading or early fetching, e.g., prefetching, ensuring that the browser focuses on fetching the most impactful resources first. This approach reduces the likelihood of unnecessary delays and helps minimize the time to critical events, creating a more responsive and fluid user experience. Simultaneously, non-essential resources can be deprioritized and/or loaded asynchronously, freeing up bandwidth and processing power for more important tasks.

Embodiments described herein provide a means to optimize webpage performance by preloading the essential resources and deprioritizing others that do not contribute directly to significant events. This technique can further be used to inform web developers about the impact of adding new resources, helping them make decisions that improve user experience by reducing loading times and enhancing the perceived responsiveness of webpages.

Additionally, embodiments described herein provide developers with deeper insight into resource dependencies, enabling them to be alerted when certain resources impact important rendering events. This functionality allows developers to make more informed and strategic decisions when adding new elements or features to a webpage. Instead of introducing elements that could unknowingly delay key rendering events or slow down the page, developers can assess the potential impact of these resources and adjust their design or loading strategies accordingly.

Moreover, by having access to a toolset that identifies necessary and unnecessary resources, developers can better prioritize preloading and caching strategies, giving critical resources priority while postponing or deferring less important assets. This intelligent resource management not only improves loading times but also helps ensure that the most visually or functionally significant parts of the page are rendered as quickly as possible, providing users with immediate feedback, and improving their overall engagement.

Once essential resources have been accurately identified, this information can be leveraged to generate targeted hints that guide the browser's loading priorities. These hints (e.g., preconnects, preloads, prefetches, lazy-load directives, and/or the like) can direct the browser to prioritize only the resources critical for specific events, ensuring that primary content loads promptly. In embodiments, hints may be defined by and/or based on a resource type, e.g., CSS, script, image, etc. Hints may indicate a preload, preconnect, and/or other type of action. A non-limiting example of a preconnect action include an indication that a connection should be established to a resource's/object's domain early but where the web browser may stop short of a preloading (or prefetching) of the resource itself. A non-limiting example of a preload action includes an indication that an entire resource/object should be downloaded early.

Disclosed herein are embodiments and applications that optimize webpage performance by introducing a novel technique for selecting and deploying hints. The techniques are designed to address the inefficiencies that occur when hints are deployed. In many instances, the deployment of hints may result in unexpected inefficiencies due to real-world limitations associated with bandwidth and or compute resources.

In embodiments, different combinations of hints yield varying effects, with some combinations enhancing performance while others inadvertently delay the loading of critical content. Current methods often apply hints in a static manner, meaning the same hints are used regardless of user context, network conditions, or specific page requirements. This static approach fails to account for the nuanced performance differences across different devices, networks, or page configurations.

For instance, in high-bandwidth environments, hints that instruct the browser to preload large resources (like images or scripts) can enhance user experience by ensuring key content loads quickly. However, if bandwidth is limited, these same hints may inadvertently compete for network resources, potentially delaying the loading of other critical assets. In such cases, preloading or prioritizing too many resources can overwhelm the network, causing essential resources to load more slowly than intended.

Similarly, compute resources affect the ability of the browser to process multiple hints simultaneously. When a device has ample processing power, hints can direct the browser to load and render content efficiently. However, on lower-powered devices, too many high-priority resources may tax the processor, leading to bottlenecks and potentially degrading the user experience.

By considering bandwidth and compute limitations, embodiments described herein can dynamically adapt hint configurations, balancing resource demands with available capacity. This ensures that hints are not only tailored to the page's structure but also optimized for the specific environment in which they're deployed, thereby maintaining efficient page loads across diverse user scenarios.

Systems and methods disclosed herein employ a feedback-driven process to automatically experiment with different hint configurations, enabling the identification of the most effective hint combinations for each page. In one example, the system can selectively experiment with different hints for different resources (e.g., such as preconnect, preload, or priority hints) and determine which type of hint for different resources will deliver the most benefit (e.g., faster load times, more responsive page, etc.). By continuously learning from performance data, the system adapts to various scenarios, providing dynamic and optimized hint sets that align with real-time needs. This approach not only maximizes page load performance but also adjusts seamlessly to diverse user environments, creating a responsive, adaptable hinting strategy that outperforms traditional methods.

The hint-tuning techniques described herein not only maximize page load performance but also adjust seamlessly to diverse user environments, creating a responsive, adaptable hinting strategy. In some embodiments, hints can be tuned in real-time based on available bandwidth, compute resources, and user-specific conditions.

In one example, the hint-tuning techniques described herein enhance the consistency of user experience across devices and network conditions. Users on high-speed connections with powerful devices benefit from quick, efficient loading of primary and secondary resources, improving overall page responsiveness and perceived snappiness. Meanwhile, users on slower networks or lower-powered devices still receive a highly optimized experience, with critical resources prioritized to ensure essential content loads first, even under resource constraints.

In another example, the capability to optimize offers competitive advantages for businesses by increasing user engagement and retention. Pages that load quickly are less likely to suffer from user drop-offs, enhancing conversion rates and user satisfaction. This performance optimization approach not only improves end-user experience but also bolsters engagement, particularly in e-commerce, media, and other web-driven industries where seamless browsing is essential for retaining users.

As will be understood, embodiments of the current disclosure are not limited to the embodiments and applications disclosed herein or to the manner in which the embodiments and applications operate or are described herein.

As used herein, “substantially” means sufficient to work for the intended purpose. If used with respect to a numerical value or range, substantially means within ten percent. The term “ones”means more than one.

As used herein, “network resources” and “webpage resources” may refer to visual (e.g., text, image, video, or the like) objects, audio objects, collections of one or more instructions (e.g., a page encoded in hypertext, a style sheet such as a cascading style sheet (CSS) for displaying and/or playing a network resource, a script file such as a JavaScript file, or the like), and/or a network service made available and/or provided by one device on a network to other devices upon request by one of the other devices. “Network resources” and “webpage resources” may be referred to herein simply as a “resource.” In embodiments, “network resources” and “webpage resources” may include the parts that a webpage needs to function and display content. Resources can include any element or aspect of a webpage including HTML code, CSS code/files, scripts, images, fonts, multimedia, libraries, plugins, data files (e.g., JSON, XML), and the like. Resources may include parts that are requested and loaded by the browser when a user visits a webpage. Resources may also include parts that are executed on a client device and, in some cases, they may include parts that are executed remotely.

As used herein, a “parent” resource includes, among other elements, one or more instructions to fetch a “child” and/or “sub” resource from a specified device. Examples of a parent/sub resource include a webpage (e.g., written in a markup language such as hypertext markup language (HTML), extensible markup language (XML), or the like), a media manifest file or other file that references other media objects (e.g., a movie, a prerecorded television show), a service providing access to a streaming media object (e.g., a podcast, a live television broadcast, streaming music, or the like) that references other media objects, a service for transferring a specified data file that references other data objects, or the like. Any of the foregoing can also be a child/sub resource. Additional examples of child/sub resources include images, audio files, video files, style files such as cascaded style sheets (CSS), executable scripts such as JavaScript, and the like. Child/sub resources may further include sub elements of resources. For example, a resource such as a script file may include a plurality of scripts, and each of the plurality of scripts may be a sub-resource of the script resources.

A “webpage element”, as used herein, may refer to blocks that define the structure, content, and/or functionality of a webpage. Webpage elements may be code definitions and/or may be associated with resources. Non-limiting examples of webpage elements include HTML tags, wherein each tag can be an element.

A “webpage event”, as disclosed herein, may refer to specific moments and/or actions that occur during the lifecycle of a webpage viewing by a user. Webpage events may occur from when a page starts loading to when the webpage is fully interactive, to after it has been displayed, to after it has been left by the user.

“Significant events”, “snappi-events”, and/or “blocking events”, as used herein, may refer to a specific webpage event and/or a set of webpage events that are designated as having and/or relating to a meaningful and/or impactful completion of the loading, rendering, and/or other similar process for a webpage, e.g., events that contribute to the “snappiness” of a webpage. Significant and/or blocking events may be attributed as significant by a user and/or by the system according to criteria and/or scoring methods. Significance may be attributed to various contexts, such as practical importance, snappiness of a page, percentage of load/render, time, etc. Examples of significant events include first paint (FP) (the first point at which anything is rendered on the screen), First Contentful Paint (FCP) (the first piece of content is painted on the screen), Largest Contentful Paint (LCP) (the largest visible element is rendered), First Meaningful Paint (the primary content of the page is rendered), Time to Interactive (TTI) (the page becomes interactive, meaning it has finished rendering content and is responsive to user inputs), DOMContentLoaded (DCL) (the initial HTML document is fully loaded and parsed, but before other resources like stylesheets, images, and scripts are fully loaded), First Input Delay (FID) (the browser to respond to the first user interaction), and the like. In embodiments significant events may include custom events that include a custom combination of one or more of loading, rendering, or interactivity milestones.

A “delay”, as used herein with respect to resources, may refer to a period of time during which access by an application, e.g., a webpage browser, to resource(s) is withheld and/or restrained. A delay may be extra and/or an additional time period as compared to the normal and/or average time period for when resources are requested, loaded, and/or made available. A delay may be purposely added and/or may occur due to operational irregularity. A delay may be inserted at a browser, external data providers, and/or the like. A delay may be added via scripts, server-side delays, browser instructions, etc. A delay from an operational irregularity may originate from network congestion, memory bottlenecks, processing limitations, etc.

A “paint area”, as used herein, may refer to an area where the browser renders elements such as text, images, videos, and other multimedia content. A paint area may be a paint of the user viewport, and/or include different shapes such as rectangles, circles, or any other shape. In embodiments, a paint area may include disjoint areas.

“Deprioritize”, as used herein, may refer to reducing the importance of resources. For example, deprioritized resources may be removed as candidates for hints.

As used herein, a “universal resource locator” specifies the location of a network resource and is sometimes abbreviated URL. In some examples, a universal resource locator includes a “host identifier” and a “resource identifier.” The “host identifier” identifies a host server from which a network resource is to be fetched, and the “resource identifier” identifies the network resource. In some examples, the resource identifier is a path to the resource on the host server. As defined and used herein, universal resource locator includes within its meaning but is not limited to what is commonly referred to in Internet or world-wide-web applications as a universal resource locator or URL.

As used with reference to a URL (whether a static URL, a resolved dynamic URL, or a resolved random-value URL) “pre-fetching” or “fetching” means obtaining the resource from the host server identified by the static or resolved URL.

As used herein “loading” a webpage is to be understood broadly. In the context of webpages, “loading of a page” refers to one or more of fetching, rendering, placing in memory, or preparing all necessary resources so that the webpage is functional. This includes not only downloading resources like HTML, CSS, Javascript, images, and fonts but also rendering these resources within the browser to visually display the content, establish interactivity, and ensure responsive behavior.

As used herein “transmitting” a webpage is to be understood broadly. In the context of webpages, “transmitting” refers to the process of delivering webpage content and resources to the client, either by sending them over a network or by providing them directly within a local server environment. When transmitting over a network, resources such as HTML, CSS, JavaScript, images, and multimedia files are sent from a remote server to the client's browser through network protocols like HTTP or HTTPS. Alternatively, in a local server environment, transmitting may involve making these resources available directly from within the server's storage, bypassing the need for external network transfer. Transmitting as used herein may also refer to passing and/or sharing data and/or values between two or more circuits and/or other devices.

Embodiments of the current disclosure may provide for improved “snappiness” which as used herein, may refer to a user's perceived responsiveness of a displayed page. For example, snappiness may refer to the responsiveness and speed with which a webpage loads and reacts to user interactions. Snappiness may also refer to and/or include a measure of one or more of parameters related to load time, interactivity (delay between user actions), smoothness (the fluidity of animations and transitions without stuttering or lag), and/or the like.

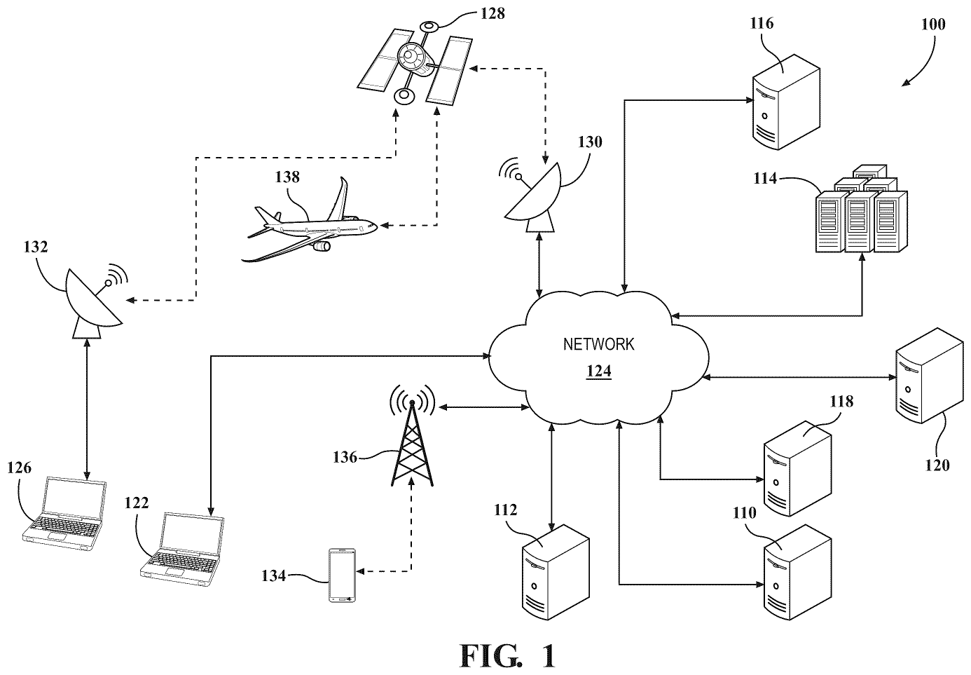

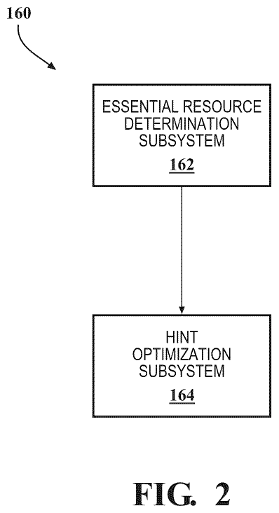

Referring now to FIG. 1, a system 100 for identifying blocking resources and tuning web browser hints may include one or more discovery servers 110 and/or one or more hint tuning servers 112. As disclosed in greater detail herein, in embodiments, the discovery servers 110 are structured to determine/detect/identify one or more blocking resources for an event associated with rendering of a webpage hosted by one or more webservers 114 that may utilize resources hosted by one or more resource servers 116 and 118. The identified significant events may be provided to the tuning server 112 that determines an optimal set of hints, hosted by one or more hint servers 120, for use by a web browser (210 in FIG. 2), also referred to herein as a webpage browser, in loading the webpage.

In embodiments, the web browser may be located on a computer 122 connected to a network 124, e.g., the Internet, via a landline, wherein the network 124 is further connected to the discovery servers 110, the hint tuning servers 112, webservers 114, resource servers 116 and 118, and/or the hint servers 120. Embodiments of the web browser may also be located on a computer 126 connected to the network via a satellite 128 with a corresponding uplink 130 and downlink 132, a computing device 134, e.g., a smart phone, connected to the network 124 via a wireless connection, e.g., WiFi and/or cellular (represented by antenna 136), and/or a mobile system 138, e.g., a vehicle such as an airplane equipped with a satellite 128 internet connection.

FIG. 2, depicts an example of a logical data flow for elements of the system. The system 160 may include a first subsystem 162 for identifying essential or blocking resources for events and a second subsystem 164 for optimizing hints. In one configuration, as shown in FIG. 2, the output of the first subsystem 162 may be the input to the second subsystem 164. In one example, elements of the first subsystem 162 may include discovery servers 110 and may be structured to determine one more blocking resources for different events. The first subsystem 162 may generate one or more lists of blocking resources for one or more significant events for a webpage. The lists of blocking resources may be used to generate hints for the page. The second subsystem 164 may be configured to optimize hints generated from the list of blocking resources. The second subsystem 164 may include one or more tuning servers 112 described in FIG. 1. The second subsystem 164 may generate an optimized set of hints (e.g., an ordered set of hints) that can be used to optimize the rendering of a webpage for a client.

The system's modules, as depicted in FIG. 2, can be used independently of one another. This modular setup provides the advantage of selectively deploying only the necessary subsystems, depending on the application requirements. For instance, in one configuration, the first subsystem 162, which identifies essential or blocking resources for significant events, may be used alone to generate hints for resource prioritization without requiring further optimization by the second subsystem 164. This configuration is particularly useful when rapid, preliminary hints are sufficient or when the overhead of additional optimization processes is not needed.

The second subsystem 164, responsible for refining and optimizing loading hints, may be deployed independently to enhance existing hints that might not have originated from the first subsystem 162. In this configuration, the second subsystem 164 could apply its optimization logic to hints derived from external sources, legacy systems, or manual inputs, making it versatile in enhancing any pre-existing hint strategies. This allows for further refinement of loading priorities, tuning hint sequences to improve resource loading efficiency, and enhancing overall page performance without dependency on the discovery output from the first subsystem.

The operations of the two subsystems 162, 164 can be performed offline within a controlled test bench environment. Running these operations offline allows for extensive testing and tuning without impacting live user experiences or network conditions. In a test bench setting, the first subsystem can identify essential or blocking resources by determining the effects of delays for resources on different events. Similarly, the second subsystem's hint optimization can be executed offline, where generated hints are refined and sequenced for optimal loading. The test bench environment allows for iterative testing of various hint configurations to see how they impact loading performance across a range of scenarios, such as different network speeds, device types, and resource loads.

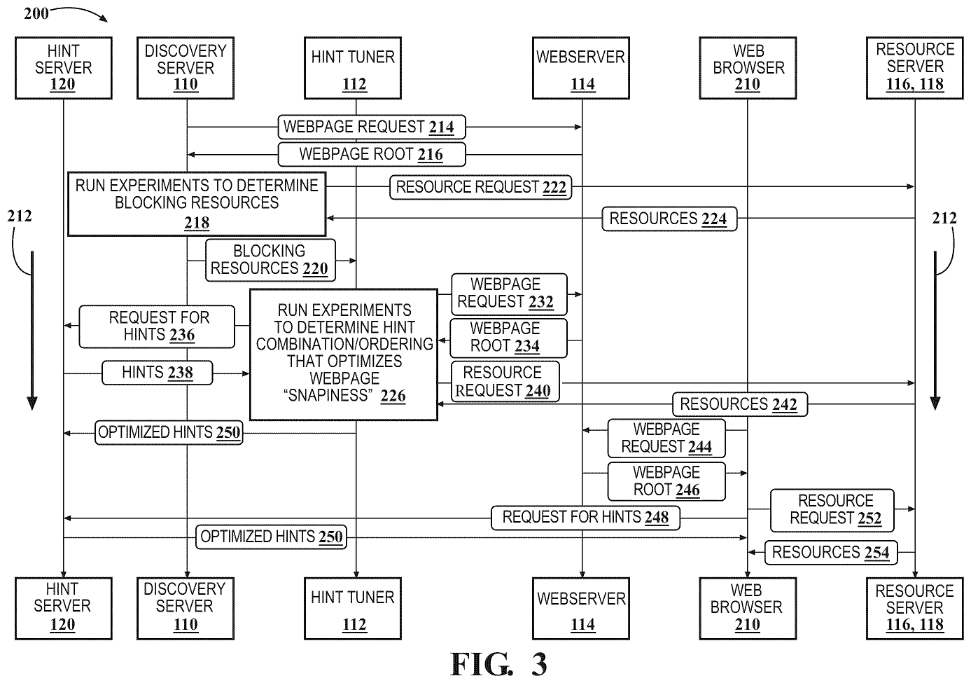

Referring to FIG. 3, time sequence diagram 200 depicts an approximation of the sequencing of processing events and messaging between the discovery servers 110, hint tuning servers 112, webservers 114, resource servers 116 and 118, hint servers 120, and web browser 210, in accordance with an embodiment of the current disclosure, wherein time flows in the direction of arrows 212. Accordingly, the discovery server 110 sends a webpage request 214 to the webserver 114 which responds back with a webpage root 216. The discovery server 110 then begins to run experiments 218 using the webpage root 216 to determine one or more essential resources 220.

In embodiments, the discovery process does not require a webserver and may be conducted locally. The discovery server 110 may be configured with the webpages such that a request from the discovery server 110 to the webserver for webpage resources may not be required.

In embodiments, the experiment 218 may include identifying essential resources for one or more significant events. In some cases, the discoverer may determine one or more blocking events by analyzing events during rendering. In embodiments, the discoverer may identify the significant resources by iteratively delaying one or more resources and monitoring the effects of the delay on the timing of the significant event(s). Based on the effects, the discoverer can determine which resources are essential for the event(s). Based on the results of the analysis, the discoverer may generate one or more lists of essential resources 220 for one or more significant events.

In embodiments, the list of resources 220 is then transmitted to the hint tuning server 112, which then runs experiments 226 to determine optimal hints 230, e.g., an ordered listing of hints structured to optimize the webpage's snappiness. In embodiments, the experiments 226 may involve loading the webpage multiple times with a browser, a modified browser, and/or an application structured to simulate the web browser 210, while timings for the significant events are measured. As such, the hint tuning server may make a webpage request 232 to get the webpage root 234, and also make a request for hints 236 to the hint server 120 to get un-modified hints 238. As part of the experiments 226, the hint tuning server 112 may then generate combinations from the hints 238 and, for each combination, simulate a loading of the webpage by requesting 240 and receiving 242 resources from the resource servers 116 and 118 in accordance with the combination.

Based on the experiments, the hint tuning server then determines/generates the optimized set of hints 230 which may then be transmitted to the hint server 120 for use in a future loading of the webpage by the web browser 210. For example, the web browser 210 may make a webpage request 244 receive the root 246, and make a hint request 248 where the hint server 120 sends back the optimized hints 250. The web browser 210 may then use the hints to prefetch resources via one or more resource requests 252 and corresponding resource retrievals 254, e.g., downloads.

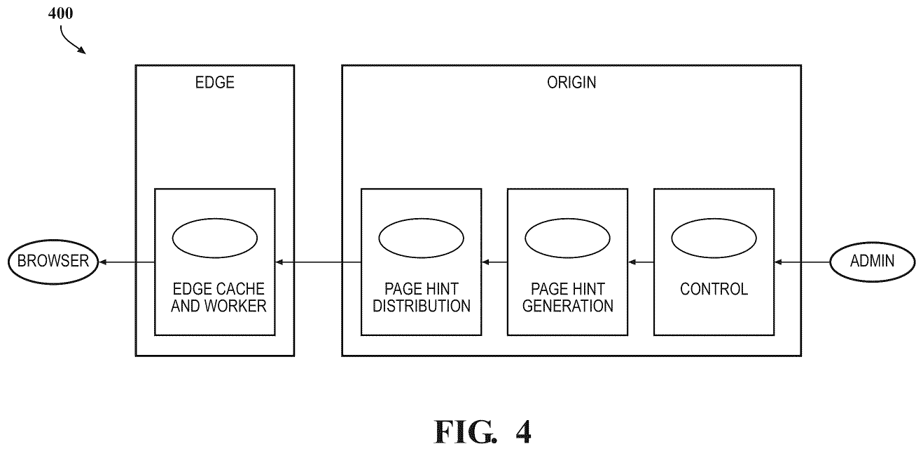

Hints generated by the system can be delivered using a hinting service. In embodiments any suitable hinting service may be used. FIG. 4 depicts some aspects of an example hinting service 400. The hinting service can be configured as a distributed system with multiple components operating across various cloud platforms. The hinting service may include origin components configured to generate, manage, and store hints. The hinting service may include edge components deployed as distributed worker servers. These edge components can deliver hints to user devices with minimal latency, accessing the nearest data center for each user's location. The edge components may be edge servers distributed geographically. By hosting edge components close to end users, the hinting service 400 can serve optimization hints in real time, adapting to specific conditions like network speed and device capabilities. This cloud-based, multi-layered architecture allows the hinting service to combine centralized hint generation with distributed, low-latency hint delivery, optimizing performance across diverse geographic and technical environments.

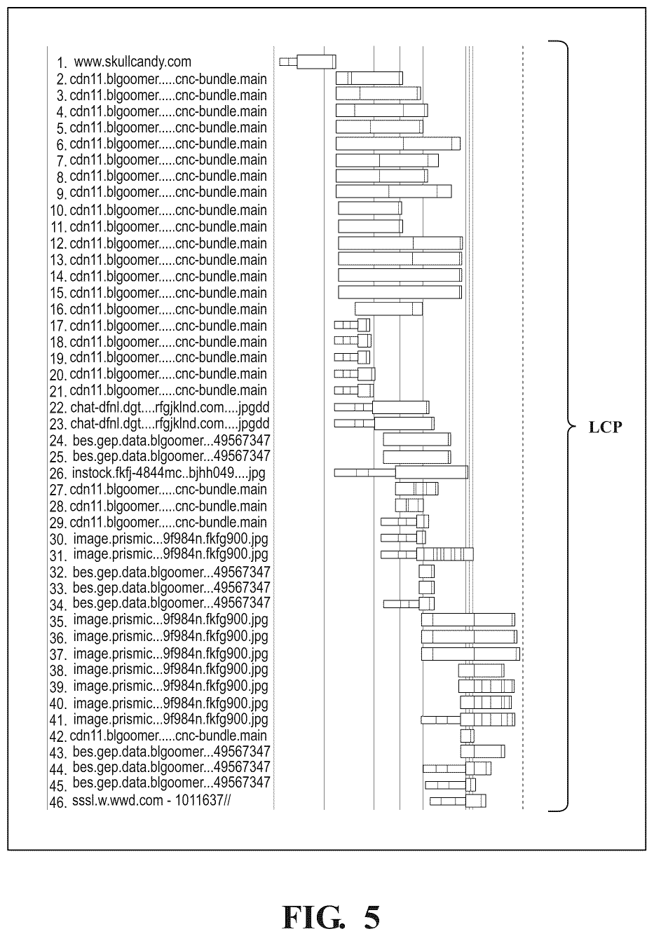

FIG. 5 depicts an example waterfall diagram that visually represents the sequence and timing of some resources loaded by a browser when rendering a webpage. The diagram includes a row for each resource (e.g., images, CSS files, JavaScript files, fonts, etc.) with a horizontal bar illustrating how long it takes to load each resource and when each phase of loading occurs. The diagram shows the sequence and duration of each resource's load time. The timeline progresses from left to right, with each resource's row divided into segments representing different loading stages that include content download, processing, rendering, and the like.

The example waterfall diagram further shows the timing of a significant event. The diagram shows the timing (depicted as a vertical dotted line) of an LCP event. The relative timing of the LCP event and the timing of the resources provide an indication of whether a resource is a necessary resource or a blocking resource for the event.

For example, if LCP occurs after a CSS file is fully loaded, this suggests the CSS was not required for the event. On the other hand, if the LCP occurs after CSS file is fully loaded, the CSS file is not necessarily essential/blocking for the LCP event.

To confirm if a resource is required for an event, a resource may be delayed, noting any impact on the event's timing due to the delay. If delaying a resource pushes the event to occur later, this confirms the resource's importance. Conversely, if delaying has no effect, it indicates that the resource is not required for the event. Repeating these observations across different resources can provide a list of the necessary resources for an event. Through a systematic analysis of the effects of delays on resources, the system can pinpoint which resources are essential for specific events, allowing for optimized loading strategies that improve page performance by prioritizing the necessary resources.

In embodiments, the system can determine essential resources for a specific event by systematically delaying individual resources and observing the effect on the timing of that event. In one example, the delay to the resources during testing may be an amount that is greater than the timing of the event under normal conditions, e.g., in the absence of the inserted delay. In embodiments, the delay set for a resource may be set to be at least nX greater than the timing of the page event, where n can be 2, 3, 4, 5, 6, 7, 8, 9, 10, or more. absence of an inserted delay, can be measured to occur at 10 ms after rendering is initiated. During testing, resources can be delayed by 20 ms, 30 ms, 40 ms, 50 ms, 60 ms, 70 ms, 80 ms, 90 ms, 100 ms, or more. If the delay of the resource also delays the significant event (e.g., by 10 ms or more), the delayed resource can be determined to be a blocking resource for the event.

In another example, testing if a resource is blocking may include visiting a webpage with a web browser and observing the first timing of a page event (e.g., 10 ms) for the webpage. The superset of resources fetched as part of the rendering of the webpage that occurs prior to the page event can be recorded. As is to be understood, the superset of resources is the set of resources that may potentially be blocking for the event. To test which of the resources in the superset of resources is blocking, the webpage may be visited a second time with a web browser. The web browser may be configured to introduce a delay prior to the fetching of one or more of the superset of resources. The delay can be set to an amount that is greater than the timing of the page event (e.g., greater than 10 ms, such as 20 ms, 30 ms, or more). The timing of the page event after the delay can be monitored. Based in part on the second timing and the amount of the delay, the system can determine that one of the superset of resources is blocking for the page event (e.g., if the event is delayed, the resource is a blocking resource).

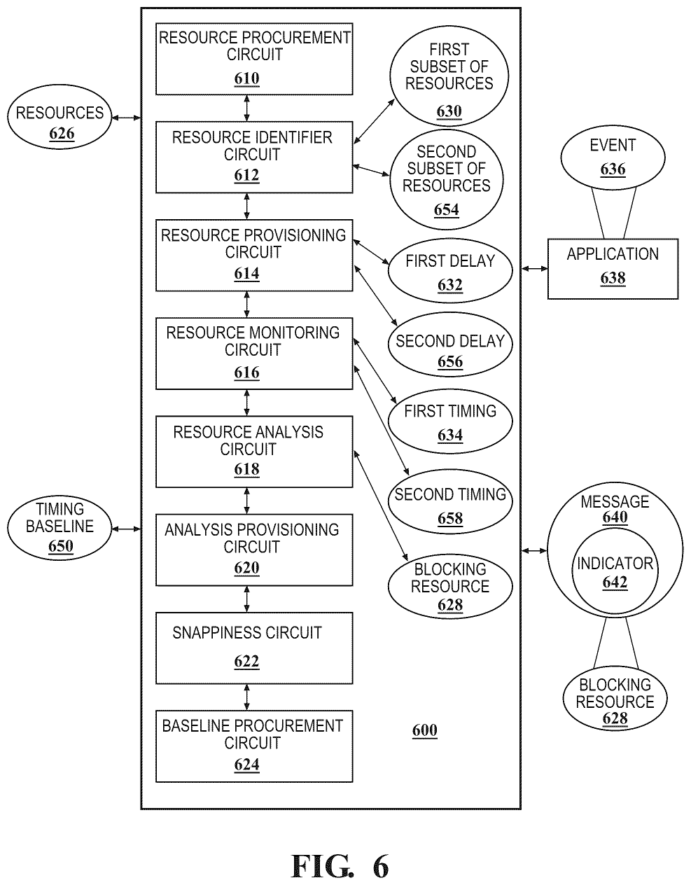

FIG. 6 depicts an apparatus 600 for identifying blocking resources, in accordance with the current disclosure. Apparatus 600 may form part of the discovery servers 110 (FIG. 1), the hint tuning servers 112 (FIG. 1), the webservers 114 (FIG. 1), resource servers 116 and 118 (FIG. 1) and/or any other computing device disclosed herein. Apparatus 600 includes a resource procurement circuit 610, a resource identifier circuit 612, a resource provisioning circuit 614, a resource monitoring circuit 616, a resource analysis circuit 618, an analysis provisioning circuit 620, a snappiness circuit, 622, and/or a baseline procurement circuit 624 that, as described in greater detail herein, interpret, process, and/or otherwise interact with associated resources, e.g., 626, 628, and 630, an associated delay 632, an associated timing 634, an associated event 636, an application 638, and/or a message 640 having an indicator 642 and blocking resource 644.

The resource procurement circuit 610 may be structured to interpret a set of resources 626. The resource identifier circuit 612 may be structured to select a first subset of resources 630 from the set of resources 626. The resource provisioning circuit 614 may be structured to transmit the set of resources 626 to an application 638, wherein the first subset of resources 630 is transmitted to the application 638 after a first delay 632. The resource monitoring circuit 616 may be structured to monitor a first execution of the application 638 that uses the set of resources 626 and determine a first timing 634 of an event 636 during the first execution. The resource analysis circuit 618 may be structured to determine, based at least in part on the first timing 634 and the first delay 632, one or more blocking resources 630, in the set of resources 626 for the event 636. The analysis provisioning circuit 620 may be structured to transmit a message 640 having an indicator 642 that identifies the one or more blocking resources 628.

In an embodiment, the application 638 may be a webpage browser.

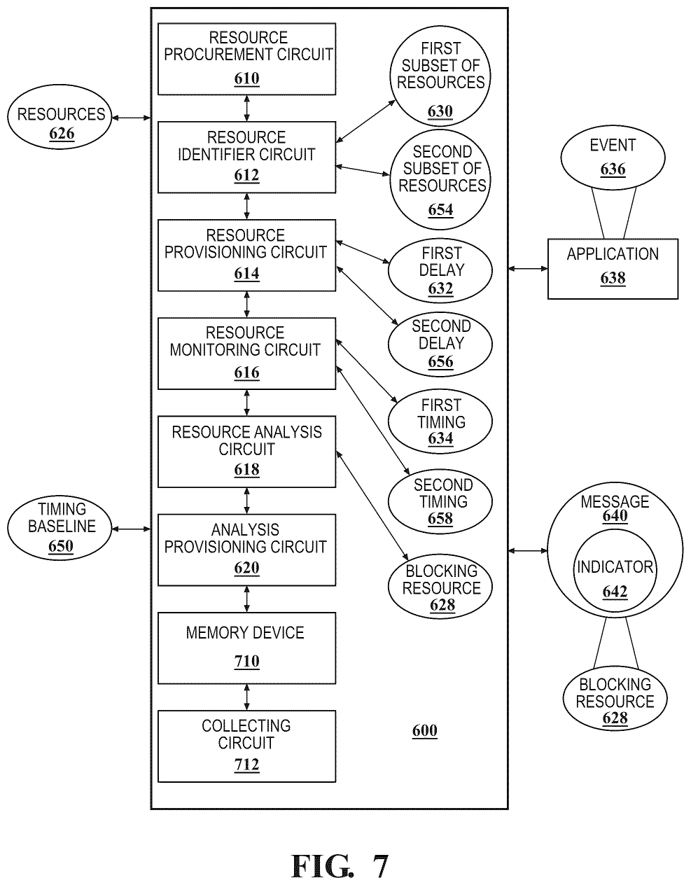

FIG. 7 depicts another embodiment of an apparatus 600 for identifying blocking resources that may include one or more of the components described herein with respect to apparatus 600 (FIG. 6) as well as a memory device 710 and/or a collection circuit 712. For example, the set of resources 626 may be for a webpage, where the collection circuit 712 may be structured to: collect the set of resources 626; and/or store the set of resources 626 and/or the webpage in the memory device 710. In such embodiments, the resource procurement circuit 610 may be further structured to retrieve the set of resources 626 from the memory device 710.

In embodiments, the event 636 may be a largest contentful paint, a first contentful object paint, a visual complete, or an update layout tree. In embodiments, one or more of the blocking resources 628 may be required for the event 636 to complete

In another embodiment, the event 636 may also be a snappi-event, as disclosed herein. In such embodiments, the snappiness circuit 622 may be structured to identify the snappi-event by analyzing a second execution of the application 648 using the set of resources 626.

In embodiments, the baseline procurement circuit 624 is structured to interpret a timing baseline 650 for the event 636, wherein the resource analysis circuit 618 is further structured to determine the one or more blocking resources 628 based at least in part on the timing baseline 650.

In another embodiment, the resource analysis circuit 618 may also include a Central Processing Unit (CPU) monitoring circuit 652 structured to monitor a CPU, on which at least part of the first execution of the application 638 occurs, and determine that at least one of the first subset of resources 626 blocks the at least part of the first execution on the CPU. In such embodiments, the resource analysis circuit 618 is further structured to determine that one or more blocking resources 628 block(s) the at least part of the first execution on the CPU.

In another embodiment, the resource identifier circuit 612 may be further structured to select a second subset 654 of resources from the set of resources 626. The resource provisioning circuit 614 may further be structured to re-transmit the set of resources 626 to the application 638, wherein the second subset of resources 654 is re-transmitted to the application 638 after a second delay 656. The resource monitoring circuit 616 may be further structured to monitor a second execution of the application 638 using the set of resource 626 and determine a second timing 658 of the event 636 during the second execution. The resource analysis circuit 618 may be further structured to determine the one or more blocking resources 628 further based at least in part on the second timing 658 and the second delay 656. The one or more blocking resources 628 may include resources in the first subset of resources 630 and the second subset of resources 654. The resource analysis circuit 618 may be further structured to compare the first timing 634 to the second timing 658, wherein the one or more blocking resources 628 may include resources in the first subset of resources 630 when the first timing 634 is longer than the second timing 658, and the one or more blocking resources 628 may include resources in the second subset of resources 654 when the second timing 658 is longer than the first timing 634.

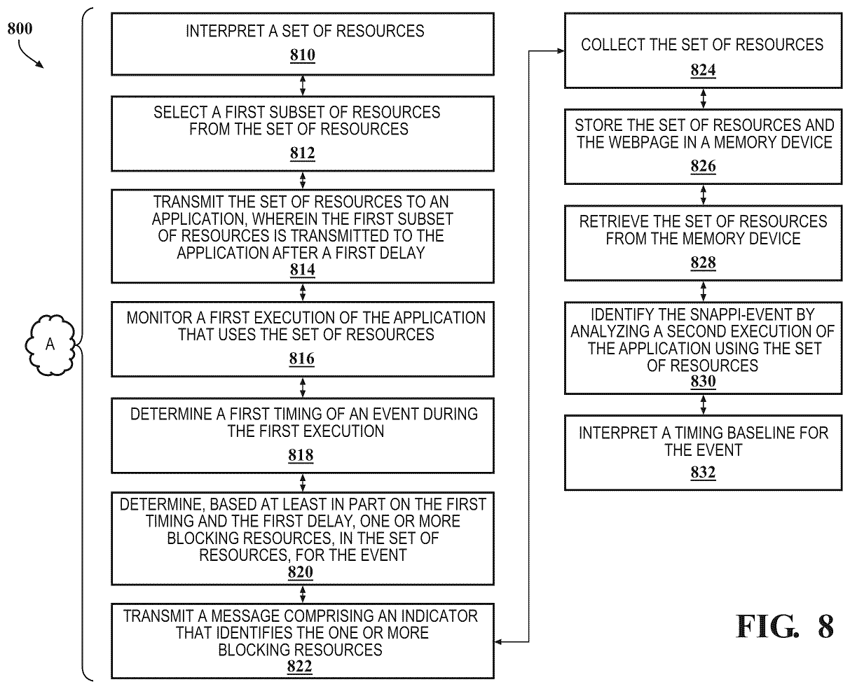

Referring to FIG. 8, a method 800 for identifying blocking resources, in accordance with an embodiment of the current disclosure. The method 800 may be performed via apparatus 600 and/or any other computing device disclosed herein. The method 800 includes: interpreting, via a resource procurement circuit, a set of resources 810. The method 800 further includes selecting a first subset of resources from the set of resources that may be selected 812. The set of resources may be transmitted via a resource provisioning circuit to an application, wherein the first subset of resources is transmitted to the application after the first delay 814. A first execution of the application that uses the set of resources may be monitored 816; a first timing of an event during the first execution may be determined 818, the one or more blocking resources may be determined for the event based at least in part on the first timing and the first delay 820. A message having an indicator that identifies the one or more blocking resources may be transmitted 822.

In embodiments of the method 800, the application may be a webpage browser and the set of resources may be for a webpage. In such embodiments, the method 800 may further include the steps of collecting the set of resources 824, storing the set of resources and/or the webpage in a memory device 826, and retrieving the set of resources from the memory device 828.

In embodiments, the event may be a largest contentful paint, an all contentful paint, a first contentful object paint, a visual complete, an update layout tree, and/or a snappi-event. In embodiments where the event is a snappi-event, the method 800 may include identifying the snappi-event by analyzing a second execution of the application using the first set of resources 830. The one or more blocking resources may be required for the event to complete.

In embodiments, the method 800 may further include interpreting a timing baseline for the event 832. In such embodiments, determining the one or more blocking resources 820 may be further based at least in part on the timing baseline, e.g., the first timing may be longer than an expected timing for the event defined by the timing baseline. The timing baseline serves as a reference point, representing the expected timing (e.g., average, or longest reasonable time) within which the event should ideally occur. By establishing this baseline, the system gains a benchmark against which the actual timing of events can be compared. In such cases, the process of identifying one or more blocking resources at step 820 is influenced by this baseline. For example, if the observed timing of an event exceeds the expected timing defined by the baseline, this discrepancy may indicate the presence of blocking resources delaying the event.

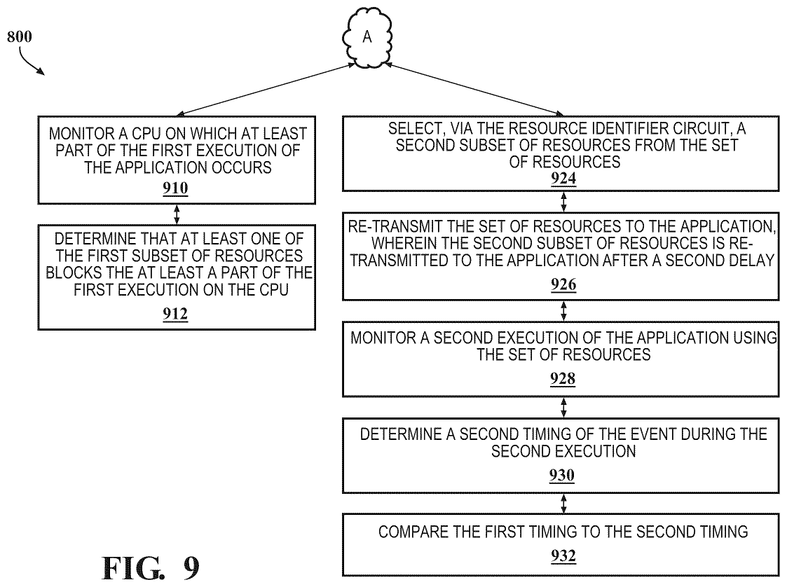

Referring now to FIG. 9, the method 800 may further include monitoring a CPU on which at least part of the first execution of the application occurs 910. The method 800 may further include determining that the one or more blocking resources may be based at least in part on the determination that the at least one of the first subset of resources blocks the at least a part of the first execution on the CPU 912.

As further shown in FIG. 9, the method 800 may include selecting a second subset of resources from the set of resources 924. In such embodiments, the set of resources may be re-transmitted to the application with the second subset of resources being re-transmitted to the application after a second delay 926. The method 800 may further include monitoring a second execution of the application using the set of resources 928, and determining a second timing of the event during the second execution 930. In such embodiments, determining the one or more blocking resources 820 (FIG. 8) may be further based at least in part on the second timing and the second delay. In such embodiments, the one or more blocking resources may include resources in the first subset of resources and the second subset of resources.

The method 800 may further include comparing the first timing to the second timing 932, where the one or more blocking resources may include resources in the first subset of resources when the first timing is longer than the second timing, and the one or more blocking resources may include resources in the second subset of resources when the second timing is longer than the first timing.

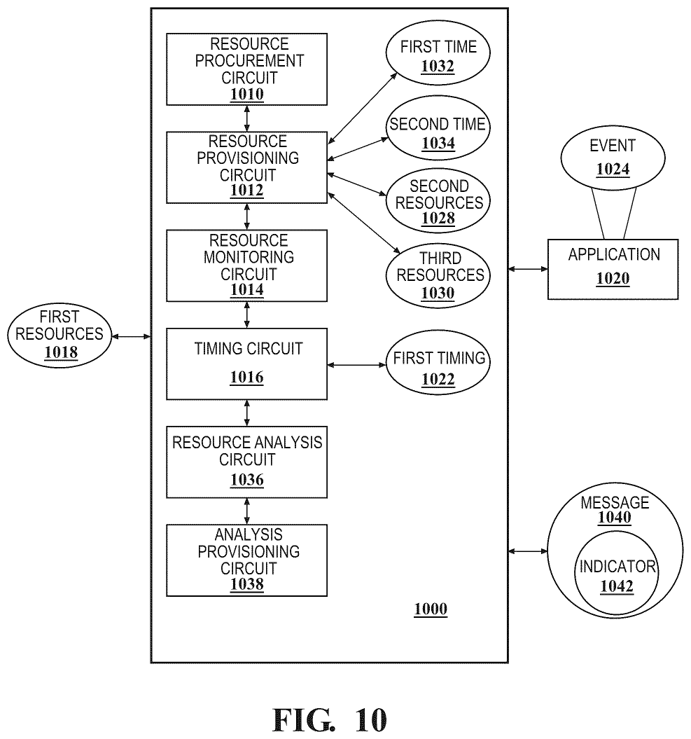

Referring now to FIG. 10, another apparatus 1000 for identifying blocking resources, in accordance with the current disclosure, may include: a resource procurement circuit 1010, a resource provisioning circuit 1012, a resource monitoring circuit 1014, and/or a timing circuit 1016 that process and/or otherwise interact with resources 1018 and an associated application 1020. Apparatus 1000 may form part of the discovery servers 110 (FIG. 1), the hint tuning servers 112 (FIG. 1), the webservers 114 (FIG. 1), resource servers 116 and 118 (FIG. 1), and/or any other computing device disclosed herein.

The resource procurement circuit 1010 may be structured to load a first set of resource 1018 for consumption by a first application 1020. The resource provisioning circuit 1012 may be structured to provide the first set of resources 1018 to the first application 1020. The resource monitoring circuit 1014 may be structured to monitor a first execution of the first application 1020 with the first set of resources 1018. The timing circuit 1016 may be structured to determine a first timing 1022 for an event 1024 during the first execution.

The resource procurement circuit 1010 may be further structured to load a second set of resources 1028 and a third set of resources 1030 for consumption by the application 1020, where the second set of resources 1028 is a subset of the first set of resources 1018 and the third set of resources 1030 is a different subset of the first set of resources 1018 from the second 1028.

The resource provisioning circuit 1012 may be further structured to provide, at a first time 1032, the second set of resources 1028 for the first application 1020. The resource monitoring circuit 1014 may be further structured to monitor a second execution of the first application 1020 with the second set of resources 1028. The resource provisioning circuit 1012 may be further structured to provide, at a second time 1034, the third set of resources 1030 for the first application 1020. The resource monitoring circuit 1014 may be further structured to monitor a third execution of the first application 1020 with the third set of resources 1030.

In embodiments, the apparatus 1000 may further include a resource analysis circuit 1036 structured to determine, from the second timing 1034, that the third set of resources 1030 includes resources that are required for the event 1024 and an analysis provisioning circuit 1038 structured to transmit a message 1040 having an indication 1042 that identifies the third set of resources 1030 includes resources required for the event 1024.

In embodiments, the application may be a webpage browser; and/or the event 1024 may be a largest contentful paint, an all contentful paint, a first contentful object paint, a visual complete, an update layout tree, and/or a snappi-event.

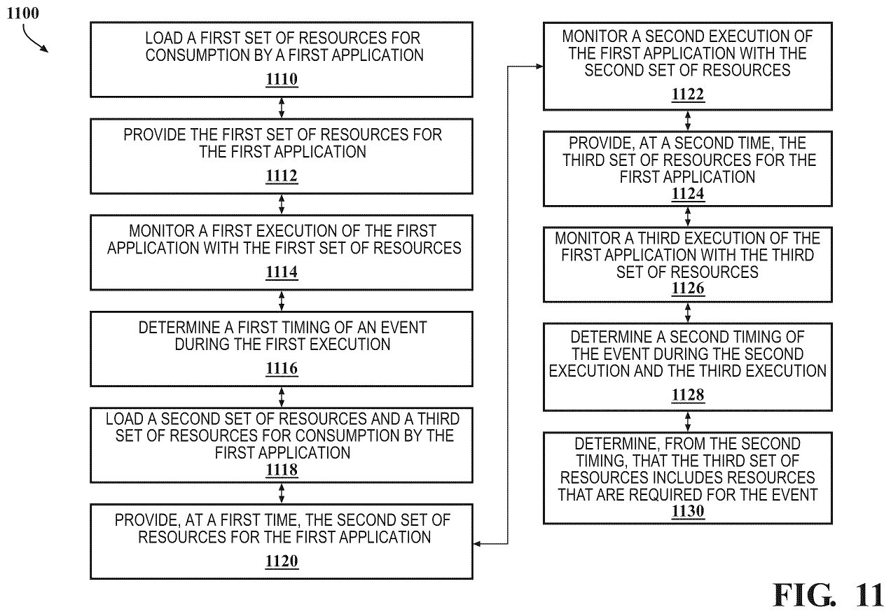

Turning now to FIG. 11, a method 1100 for identifying blocking resources is shown. The method 1100 may be performed via apparatus 1000 and/or any other computing device disclosed herein. The method 1100 includes: loading a first set of resources for consumption by a first application 1110; providing the first set of resources to the first application 1112, and monitoring a first execution of the first application with the first set of resources 1114. The method 1100 further includes determining a first timing of an event during the first execution 1116, and loading a second set of resources and a third set of resources for consumption by the first application 1118, where the second set of resources is a subset of the first set of resources and the third set of resources is a different subset of the first set of resources.

The method 1100 further includes providing the second set of resources to the first application at a first time 1120, and monitoring a second execution of the first application with the second set of resources 1122. The method 1100 further includes providing the third set of resources to the first application at a second time 1124, and monitoring a third execution of the first application with the third set of resources 1126. The method 1100 further includes determining a second timing of the event during the second execution and third execution 1128, and determining, from the second timing, that the third set of resources includes resources that are required for the event 1130.

In embodiments, the application may be a webpage browser, and the event may be a largest contentful paint, an all contentful paint, a first contentful object paint, a visual complete, an update layout tree, and/or a snappi-event.

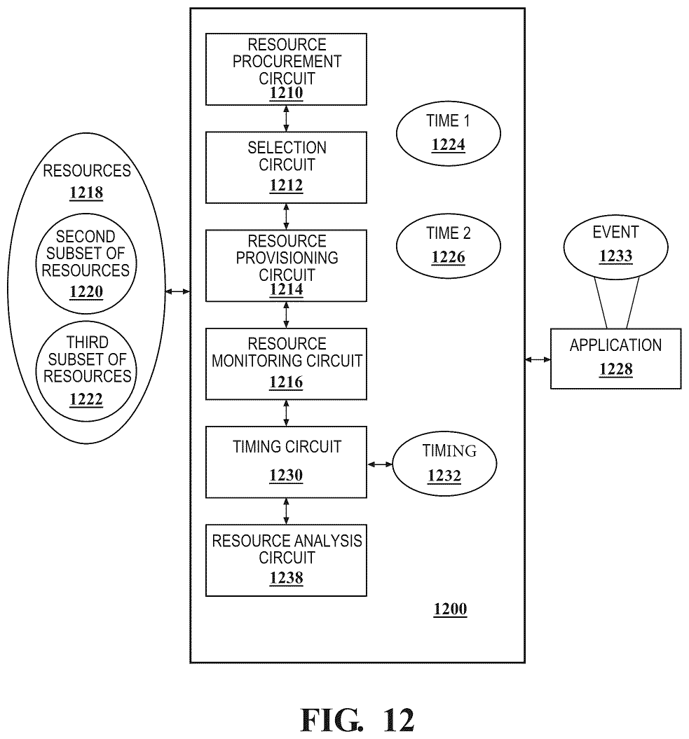

Moving now to FIG. 12, another apparatus 1200 may include a resource procurement circuit 1210, a selection circuit 1212, a resource provisioning circuit 1214, and/or a resource monitoring circuit 1216 that may process and/or interact with resources 1218, 1220, 1222, associated timings 1224, 1226, and associated application 1228. Apparatus 1200 may form part of the discovery servers 110 (FIG. 1), the hint tuning servers 112 (FIG. 1), the webservers 114 (FIG. 1), resource servers 116 and 118 (FIG. 1), and/or any other computing device disclosed herein.

The resource procurement circuit 1210 may be structured to load a first set of resources 1218, and the selection circuit 1212 may be structured to select, from the first set of resources 1218, a second set of resources 1220 and a third set of resources 1222, where the second set of resources 1220 is a subset of the first set of resources 1218 and the third set of resources 1222 is a different subset of the first set of resources 1218 than the second 1220.

The resource provisioning circuit 1214 may be structured to provide, at the first time, the second set of resources 1220 for the application 1228, and further structured to provide, at a second time, the third set of resources 1222 the first application 1228. The resource monitoring circuit 1216 may further be structured to monitor a second execution of the first application 1228 with the third set of resources 1222. The apparatus 1200 may further include a timing circuit 1230 structured to determine a timing 1232 of an event 1233 during the first execution and the second execution.

The apparatus 1200 may further include a resource analysis circuit 1238 structured to determine, based on the first time, the second time, and the timing, that the third set of resources 1222 includes resources that are required for the event 1233. The application 1228 may be a webpage browser, a largest contentful paint, an all contentful paint, a first contentful paint object, a visual complete, an update layout tree, and/or a snappi-event.

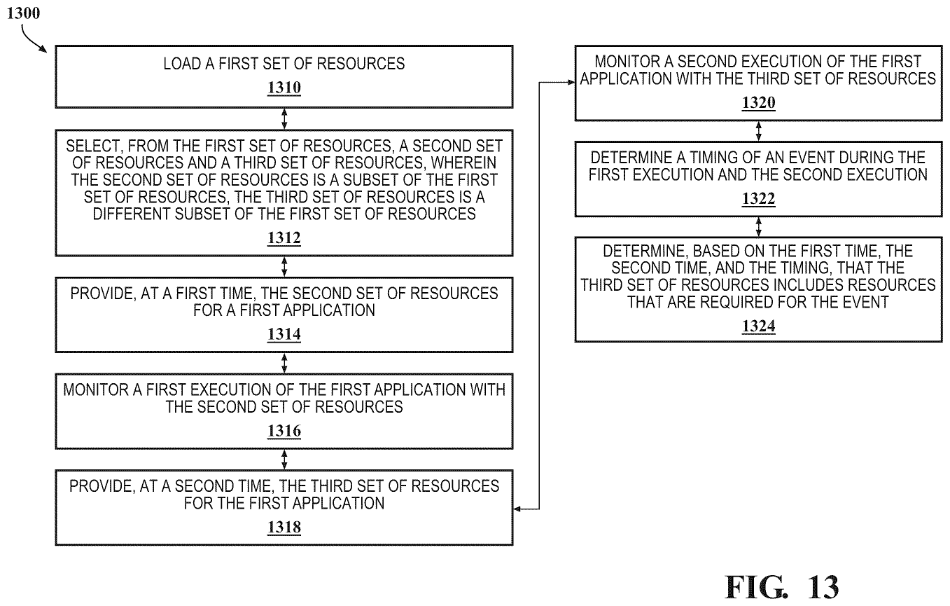

Turning now to FIG. 13, another method 1300 for identifying blocking resources is shown. The method 1300 may be performed via apparatus 1200 and/or any other computing device disclosed herein. The method 1300 includes: loading a first set of resources 1310; and selecting from the first set of resources, a second set of resources and a third set of resources 1312. The second set of resources may be a subset of the first set of resources and the third set of resources may be a different subset of the first set of resources than the second. The method 1300 further includes: providing, at a first time, the second set of resources for a first application 1314; and monitoring a first execution of the first application with the second set of resources 1316. the method 1300 further includes providing the third set of resources for the first application at a second time 1318, and monitoring execution of the first application with the third set of resources 1320. The method 1300 further includes determining a timing of an event during the first execution and the second execution 1322, and determining, based on the first time, the second time, and the timing, that the third set of resources includes resources that are required for the event 1324.

In embodiments, the application may be a webpage browser, and the event may be a largest contentful paint, an all contentful paint, a first contentful object paint, a visual complete, an update layout tree, and/or a snappi-event.

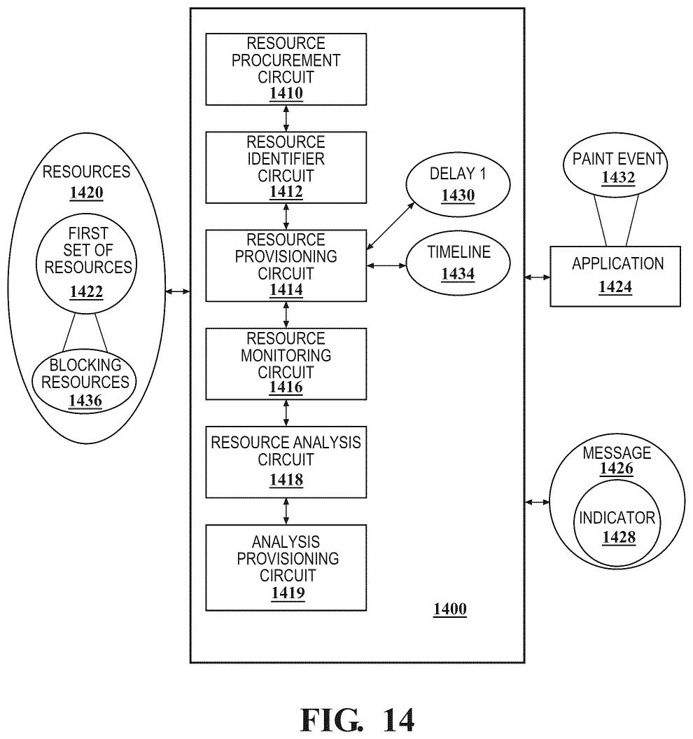

Moving to FIG. 14, another apparatus 1400 for identifying blocking resources includes a resource procurement circuit 1410, a resource identifier circuit 1412, a resource provisioning circuit 1414, a resource monitoring circuit 1416, a resource analysis circuit 1418, and/or an analysis provisioning circuit 1419, which may process and/or otherwise interact with associated resources 1420 and 1422, an associated application 1424, and an associated message 1426 with indicator 1428. Apparatus 1400 may form part of the discovery servers 110 (FIG. 1), the hint tuning servers 112 (FIG. 1), the webservers 114 (FIG. 1), resource servers 116 and 118 (FIG. 1), and/or any other computing device disclosed herein.

The resource procurement circuit 1410 may be structured to interpret a set of resources 1420, and the resource identifier circuit 1412 may be structured to select, from the set of resources 1420, a first subset of resources 1422. The resource provisioning circuit 1414 may be structured to transmit the set of resources 1420 to the application 1424, wherein the first subset of resources 1422 are transmitted after a first delay 1430, and the resource monitoring circuit 1416 is structured to monitor a first execution of the application 1424 using the resources 1420, and further structured to monitor one or more paint events 1432 for one or more areas of a page. The resource analysis circuit 1418 may be structured to determine a timeline 1434 of the one or more paint events and determine, based on the timeline and the first delay 1430, that the first subset of resources 1422 includes one or more blocking resources 1436 for the one or more paint events 1432. The analysis provisioning circuit 1419 may be structured to transmit the message 1426, where the indicator 1428 identifies the one or more blocking resources 1436.

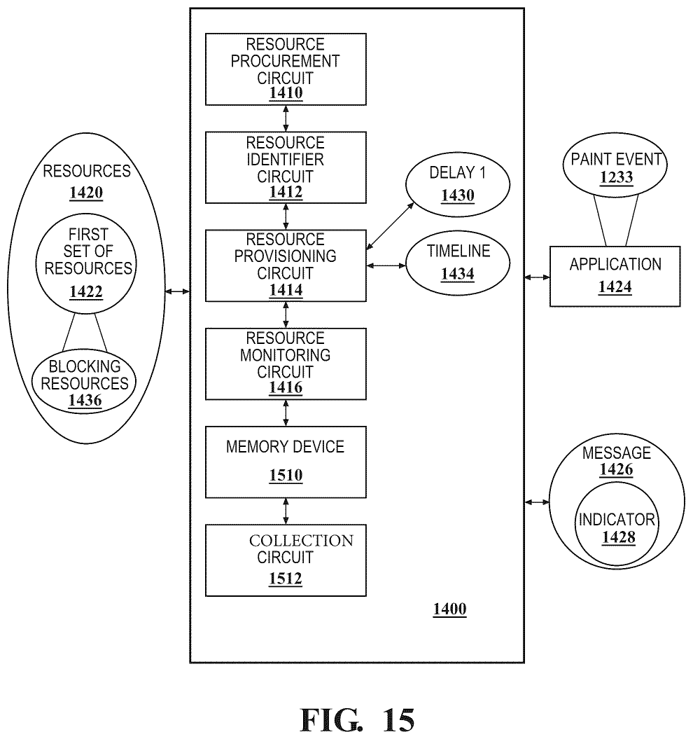

FIG. 15 depicts an embodiment of apparatus 1400 having a memory device 1510 and a collection circuit 1512, wherein the set of resources 1420 are for a webpage. In such embodiments, the collection circuit 1512 is structured to collect the set of resources 1420 and to store the set of resources 1420 and/or the webpage in the memory device 1510, where the resource procurement circuit 1410 may be further structured to retrieve the set of resources 1420 from the memory device 1510.

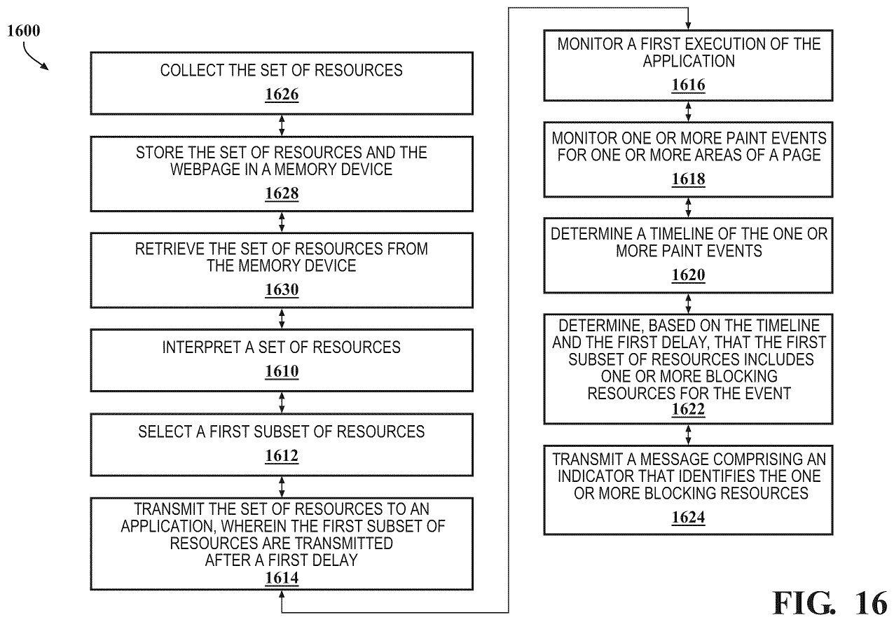

FIG. 16 depicts another method 1600 for identifying blocking resources, in accordance with embodiments of the current disclosure. The method 1600 may be performed via apparatus 1400 and/or any other computing device disclosed herein. The method 1600 includes: interpreting a set of resources 1610; selecting a first subset of resources from the set of resources 1612; and transmitting the set of resources to an application 1614, where the first subset of resources are transmitted after a first delay. The method 1600 further includes: monitoring a first execution of the application 1616; and monitoring one or more paint events for one or more areas of a page 1618. The method 1600 further includes determining a timeline of the one or more paint events 1620; and determining, based on the timeline and the first delay, that the first subset of resources includes one or more blocking resources for the event 1622. The method 1600 further includes transmitting a message having an indicator that identifies the one or more blocking resources 1624.

In embodiments, the application may be a webpage browser, and the set of resources may be for a webpage. In such embodiments, the method 1600 further includes: collecting the set of resources 1626; storing the set of resources and the webpage in a memory device 1628; and retrieving the set of resources from the memory device 1630.

As webpages evolve, their structure and resource dependencies often change, requiring periodic sanity checks to verify the validity of previously identified critical resources. New content, features, scripts, or third-party integrations introduced to a page can alter the loading dynamics and dependencies, potentially impacting which resources are essential for events. For instance, a script once deemed non-critical might become integral to the page's interactivity due to new functionalities, or new image assets might be required for primary content, changing their prioritization.

In embodiments, a sanity check involves the delay of non-critical resources. A sanity check is a validation step used to confirm which resources are genuinely non-essential for key page events and to confirm that the lists of essential resources are correct. By delaying all or a subset of identified non-blocking elements and observing whether this affects the timing of significant events, the system can verify if the resources labeled as “non-critical” truly do not impact the associated events.

In embodiments, sanity checks include delaying the loading of the identified non-blocking elements for an event to observe if the timing of the significant event is affected. If there's no delay in the event, the assumption that these elements are non-critical is validated which also means that the identified critical resources are also valid. If the sanity check fails (i.e., reveals that delaying the non-blocking elements affects event timing), a rerun of the resource analysis may be triggered.

In some embodiments, a targeted approach can be used during the sanity check by selecting only a specific subset of non-critical elements for testing. This selection may be strategically determined to maximize the effectiveness of the sanity check while minimizing unnecessary processing. The subset of elements chosen for delay testing can be based on various criteria, including the type of resource, its file size, its position within the overall loading sequence, and the like. For example, resources such as large images or complicated JavaScript files may be prioritized for sanity checks, as these larger assets can often contribute to unintended delays if they influence the timing of critical events more than anticipated. Additionally, resources that load early in the sequence may be selected, as they are more likely to interact with and potentially block key rendering milestones.

In embodiments re-evaluation can be based on either the “freshness” of new resource data or the failure of the sanity checks, indicating that adjustments to resource categorization may be necessary.

In certain embodiments, the system's re-evaluation of resources may be triggered by either the “freshness” of new resource data or the failure of previous sanity checks, each serving as an indicator that adjustments to resource categorization (e.g., essential or non-essential for a given event) might be needed. When the system identifies new resource data that has not yet been incorporated into the existing resource categorization, it may prompt a re-evaluation to ensure that the latest elements and dependencies are accounted for in performance optimization strategies. Additionally, the failure of a sanity check indicates that the current categorization may inaccurately represent some resources as non-essential for an event. This failure signals the need for a re-evaluation.

While the examples described herein focus on the loading of visual resources, it is important to note that compute resources may also block page events and impact overall page performance. Compute resources (e.g., such as JavaScript execution, layout recalculations, data parsing, etc.) consume significant CPU time and can delay significant events (e.g., FCP, TTI). Unlike static loading resources, compute tasks are dynamic and may be triggered by user interactions or conditional content loading. When these compute tasks occupy CPU resources, they can prevent other essential processes from executing efficiently, thereby blocking or delaying significant events.

In embodiments, identifying blocking compute tasks may include analyzing specific operations requiring CPU power, such as JavaScript-heavy interactions, DOM updates, style recalculations, and other tasks triggered during user interactions or content loading. These CPU-intensive tasks can create noticeable delays, especially on resource-constrained devices, as they prevent the browser from responding to user inputs or efficiently loading of other essential resources. In many webpages, compute tasks are often dynamic, initiated by scripts, user actions, or conditional content loading.

For example, a JavaScript file may be essential for a compute task that updates content dynamically, while certain fonts or styles might trigger layout recalculations that consume CPU time and delay the initiation of key events.

Disclosed herein are embodiments and applications that optimize webpage performance by introducing novel techniques for selecting and deploying browser hints. Disclosed techniques address the common inefficiencies that can arise when hints (e.g., preconnect, preload, and priority hints) are used without adapting to real-world conditions. In current systems, hints are often applied uniformly, regardless of the environment in which they operate. This lack of adaptability can lead to inefficiencies, as hints may not be suitable for the specific network conditions or device capabilities, resulting in slower load times and a suboptimal user experience.

In one example, preloading or preconnecting resources without considering available bandwidth can overwhelm limited network resources. For instance, in low-bandwidth environments, preloading multiple large resources may slow down critical asset delivery, delaying the visible content users need to engage with the page. Additionally, some devices may lack the compute resources required to process all preloaded or prioritized assets efficiently, leading to browser strain and, ultimately, degraded page performance. The disclosed techniques allow for a more responsive hint deployment strategy that is adapted to available bandwidth and/or compute power, preventing such bottlenecks.

The disclosed techniques leverage a feedback-driven approach to fine-tune hint configurations accordingly. By analyzing metrics from past page loads, this method identifies which hints are beneficial in varying scenarios, effectively balancing resource-intensive preloads with selective preconnects. This enables the system to avoid unnecessary resource consumption and prioritize only those hints that meaningfully enhance load times.

Furthermore, the system optimizes the timing of hint deployment, choosing the best moment to apply each hint. In one example, hints can be provided during two different phases. The first phase occurs before the root HTML document arrives, where the browser can begin loading essential resources early using an Early Hint (HTTP 103) or an Optimization Guide Service (OGS) hint in Chromium browsers. These early hints allow the browser to preconnect to necessary domains, preload critical assets, or assign priority to key resources before receiving the main HTML document. Early hints are particularly effective for reducing latency since they enable the browser to initiate connections and resource loading while awaiting the full page content, resulting in faster initial render times.

The second phase of occurs with the root HTML document's arrival, where hints can be delivered as part of a response. In one example second phase may occur with HTTP 200 response headers or embedded directly within the HTML of the root object itself. For example, a webpage's HTTP 200 response might include headers that tell the browser to preload a CSS file or preconnect to an external image CDN.

A process for determining which resources should receive different types of hints (e.g., preconnect, preload, prefetch, etc.) and/or the timing of the hints (e.g., early HTTP 103 and/or HTTP 200) can include steps of initial data collection, and feedback driven refinement. In one example, the process may begin with collecting data on resource loading behavior during page loads, both in simulated environments and real-world scenarios. This data includes information about resource types (e.g., images, CSS, JavaScript), file sizes, loading times, and network requests. Additionally, event data (e.g., Largest Contentful Paint (LCP), paint event, etc.) and the respective blocking resources may be determined using the techniques described herein. With the resources identified, the system may assign appropriate hint types to the blocking resources.

In embodiments, the process may change the hint types associated with the blocking resources and monitor webpage metrics (e.g., load times, snappiness, etc.) to determine which assignment results in the best performance (e.g., lowest load times, quickest response time, etc.).

In one embodiment, the process may systematically experiment with combinations of different hint type assignments for the resources. This experimentation may involve testing various permutations of preconnect, preload, prefetch, and priority hints and/or the timing of the hints across the full set of page resources (e.g., CSS files, JavaScript, images, and external fonts, etc.) to determine which combinations yield the best performance. The systematic experimentation can begin by isolating each resource and applying individual hint types, then progressively testing multiple hints in combination. For instance, an initial test might assign a preconnect hint to a CSS file, while a preload hint is assigned to a primary image required for initial rendering. As tests proceed, the system evaluates metrics like page render time, timing of paint events, overall network latency, and/or the like to gauge the effectiveness of each hint configuration. The experimentation process can include various timing options for each hint type, such as deploying hints early (e.g., using HTTP 103 Early Hints) or waiting to include them in the main HTML (e.g., using HTTP 200 response).

In one embodiment, the process may utilize heuristics to experiment with different combinations of hint-type assignments for each resource, aiming to identify the optimal configuration for specific page load scenarios. This heuristic-driven approach intelligently narrows down the number of hint configurations to test, focusing on combinations that are more likely to improve load performance based on prior knowledge, best practices, and contextual information about the page and its resources. Rather than exhaustively testing every possible combination, heuristics allow the process to concentrate on the most promising configurations, making the experimentation phase more efficient and less resource intensive. The heuristics may consider factors such as resource criticality, dependency chains, and loading sequence. For example, the system may prioritize applying preload hints to render-blocking resources like CSS files or images in the viewport, while preconnect hints could be applied to external domains that host essential scripts or media files. Additionally, the heuristics might assign lower priority to hints for non-critical resources, such as those that only load once the user begins to scroll.

In one embodiment, the process may utilize trained machine learning models to intelligently experiment with different combinations of hint-type assignments for each resource, adapting to the specific needs of each page load scenario. By leveraging models trained on historical data and previous page load performance, the system can predict which hint combinations are likely to yield the most efficient loading times, allowing it to selectively experiment with the most promising configurations. This approach reduces the computational expense of exhaustive testing by focusing on combinations that align with established performance patterns and resource priorities.

Testing of hints can be conducted in either a real system environment or a simulated environment. In a real system environment, hint configurations can be tested under true user conditions, providing insights into how hints perform with actual device hardware, network variability, and user behavior. The real-world testing allows for accurate assessment of hint effectiveness in live scenarios, revealing how well the hints improve load times and user experience across a range of unpredictable conditions. Testing in a real environment can also help detect edge cases or unexpected interactions that might not surface in controlled conditions.

Testing of hints can be conducted in a simulated environment. A simulated environment offers control over a wide range of variables, such as device specifications, network characteristics, and cache states, enabling systematic experimentation with hint configurations. In a controlled setting, testing can be performed across a variety of defined scenarios, including high-latency networks, limited bandwidth, and low-power devices, without the interference of random external factors. Simulated testing is particularly advantageous during the tuning phase, as it allows the system to fine-tune hint combinations to determine the optimal configurations for different conditions before deploying them broadly. By adjusting specific parameters (e.g., browser version, operating system, cache state, and network conditions) the simulated environment provides insights into how hints affect load times and performance consistency across diverse configurations and/or tailor hints for specific configurations.

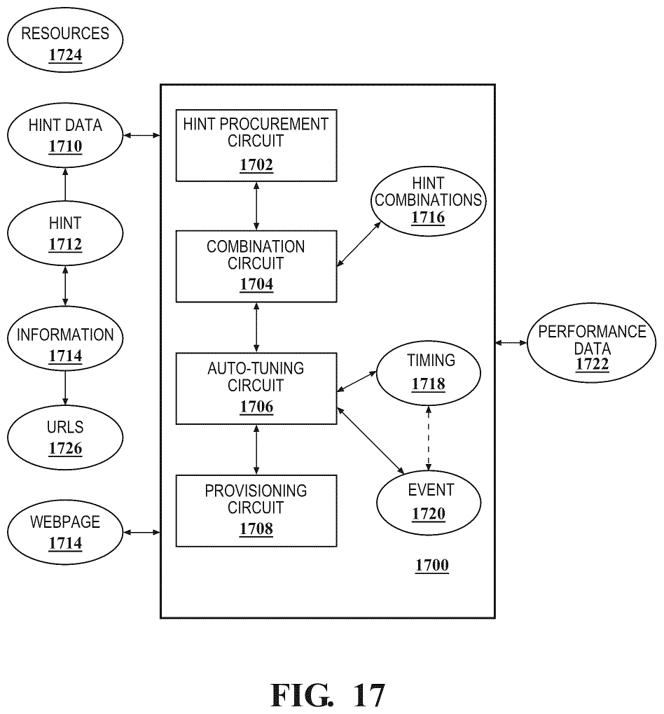

Illustrated in FIG. 17 is an embodiment of an apparatus 1700 for tuning hints for a webpage. Apparatus 1700 may form part of the discovery servers 110 (FIG. 1), the hint tuning servers 112 (FIG. 1), the webservers 114 (FIG. 1), resource servers 116 and 118 (FIG. 1), and/or any other computing device disclosed herein. The apparatus 1700 includes a hint procurement circuit 1702, a combination circuit 1704, an auto-tuning circuit 1706, and a performance provisioning circuit 1708.

The hint procurement circuit 1702 is structured to interpret hint data 1710, which may define a plurality of hints 1712 structured to facilitate loading of a webpage 1714. The combination circuit 1704 is structured to generate a plurality of hint combinations 1716 from the plurality of hints 1712. The auto-tuning circuit 1706 is structured to load, for each of the plurality of hint combinations 1716, the webpage 1714 using the hint combination 1716. The auto-tuning circuit 1706 is further structured to determine, for each loading of the webpage 1714, a timing 1718 for an event 1720 associated with the loading of the webpage 1714. Further, the auto-tuning circuit 1706 is further structured to generate, based at least in part on the timings 1718, performance data 1722 for the plurality of hint combinations 1716. The performance provisioning circuit 1708 is structured to transmit the performance data 1722.

In embodiments, the plurality of hints 1712 includes information 1728 for locating one or more resources 1724 used to load the webpage 1714. In another example embodiment, the plurality of hints 1712 includes one or more child universal resource locators (URLs) 1726. In another example embodiment, the resources 1724 are elements rendered on the webpage 1714. In an example embodiment, the resources 1724 are graphics.

In embodiments, the event 1720 may be a largest contentful paint, an all contentful paint, a paint event, a first contentful object paint, a visual complete, and/or an update layout tree.

In embodiments, the combination circuit 1704 may be further structured to generate the plurality of hint combinations 1716 based at least in part on the event 1720. In embodiments, the event 1720 may be snappi-event. For example, embodiments of the combination circuit may generate the hint combinations via searching over browser hint combinations using a cluster of web browsers to automatically find suitable and/or the best preconnect, preload, priority hints, and/or other types of hints, and to find the best timing to deliver them to improve and/or maximize a user's perceived snappiness. For example, the generation of hint combinations may be based at least in part on varying one or more hint variables associated with a resource, e.g., fetching priority, whether to preconnect, prefetch, and/or preload a particular resource, and/or the like. In embodiments, a hint combination may be a set of hints with a particular set of priorities/tags associated with one or more resources. For example, a first subset of a hint combination may include hints that have been designated for prefetching, while a second subset of the hint combination may include hints that have been designated for preconnecting, as opposed to prefetching. Other combinations may vary the members of the first and/or second sets and/or vary other properties of the resources, e.g., priority. For example, the hints in the first subset may be given a higher priority than the hints in the second subset. In embodiments, a combination may include a first subset of hints designated for early hint injection, e.g., for retrieval via a hint server, while a second subset of hints may be designated for late hint injection, e.g., the hints may be transmitted with a root of the webpage. In other words, embodiments of the hint combinations may vary when a hint should be delivered, e.g., early via a hint server or late with a webpage root, and/or vary the aggressiveness/priority of the hints, e.g., high, medium, low, etc. In embodiments, an early hint may be a hint for a webpage that arrives at a web browser before a root of the webpage is received, e.g., an HTTP 103 early hint from a content delivery network (CDN), and a late hint may be a hint for the webpage that is received with or after the root of the webpage is received., e.g., within a header file for the webpage or embedded in the HTML for the root and/or as part of an HTTP 200 response.

In embodiments, the performance data 1722 includes one or more of the timings 1718 and/or one or more of the plurality of hint combinations 1716. In embodiments, the performance data 1722 associates each of the one or more timings 1718 to one of the plurality of hint combinations 1716.

In embodiments, at least one of the hint combinations 1716 includes an ordered set of hints of at least some the plurality of hints 1712. In example embodiments, the ordered set of hints may be based at least in part on a prefetching priority. In another example embodiment, the ordered set of hints may be based at least in part on a network resource. In another example embodiment, the ordered set of hints may be based at least in part on an expected bandwidth of at least one network connection. In another example embodiment, the ordered set of hints may be based at least in part on a compute resource. In example embodiment, the ordered set of hints may be based at least in part on an available memory.

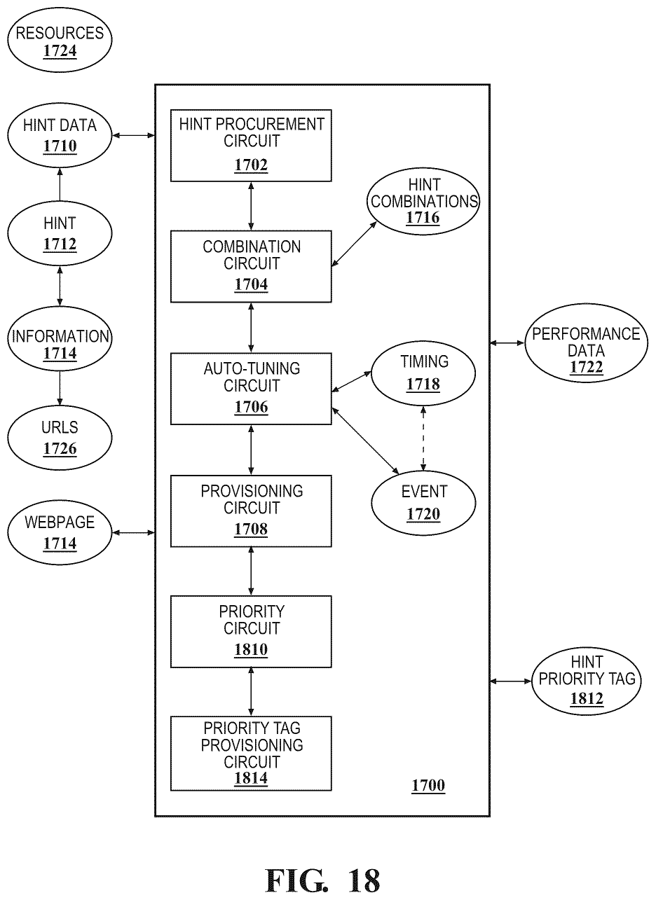

FIG. 18 is an example embodiment of the apparatus 1700 further including a priority circuit 1810 structured to generate a hint priority tag 1812 for an element of the webpage 1714 based at least in part on the performance data 1722, e.g., “fetchpriority=‘high’” added to an HTML tag for an image, such as <img src=“photo.jpg” fetchpriority=“high”. Embodiments may also have a priority tag provisioning circuit 1814 structured to transmit the hint priority tag 1812. While the foregoing example disclosed a hint priority tag with respect to HTML, it should be understood that embodiments of the hint priority tag are applicable to other types of tag languages, e.g., XML, and/or other languages and/or systems where priority can be given to objects. In other words, in embodiments, the hint priority tag 1812 may be any type of data value or construct that imparts and/or sets a priority value to a data object.

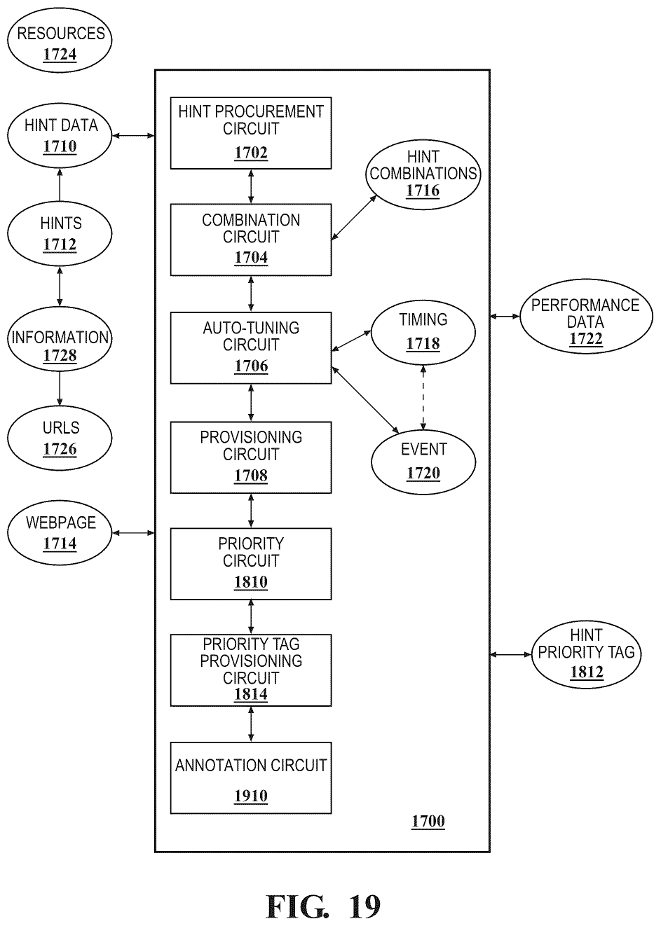

FIG. 19 is an example embodiment of the apparatus 1700 in FIG. 17 where the apparatus 1700 further includes an annotation circuit 1910 structured to inject the hint priority tag 1812 into the webpage 1714. In example embodiment, the hint priority tag 1812 is structured to be injected/inserted into a HyperText Markup Language (HTML) data file for the webpage 1714.

In embodiments, the auto-tuning circuit 1706 may be further structured to analyze the performance data and select one of the hint combinations 1716 as being the best/optimized hint combination that improves the snappiness of the webpage by improving the loading and/or rendering time of the event 1720.

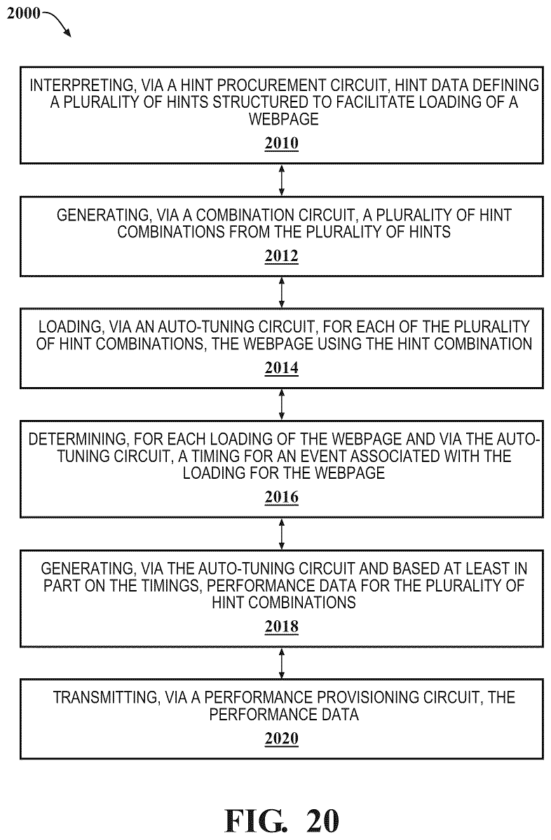

FIG. 20 is an example method 2000 that may be performed via apparatus 1700 and/or any other computing device disclosed herein. The method 2000 includes interpreting, via a hint procurement circuit, hint data to define a plurality of hints structured to facilitate loading of a webpage 2010. Further, the method generates, via a combination circuit, a plurality of hint combinations from the plurality of hints 2012, and loading, via an auto-tuning circuit, for each of the plurality of hint combinations, the webpage using the hint combination 2014.

The method also includes determining, for each loading of the webpage and via the auto-tuning circuit, a timing for an event associated with the loading for the webpage 2016, and generating, via the auto-tuning circuit and based at least in part on the timings, performance data for the plurality of hint combinations 2018. Lastly, the method includes transmitting, via a performance provisioning circuit, the performance data 2020.

In example embodiment, the plurality of hints includes information for locating one or more resources used to load the webpage. In example embodiments, the plurality of hints includes one or more child universal resource locators (URLs). In example embodiments, the resources are elements rendered on the webpage. In example embodiments, these elements include graphics. In embodiments, the plurality of hints may include indications to preload a resource or to preconnect to the resource's location/domain.

In example embodiments, the event in FIG. 20 is a largest contentful paint. In other example embodiments, the event is an all contentful paint. In example embodiments, the event is a first contentful object paint. In example embodiment, the event is a visual complete. In example embodiments, the event is update layout tree.

In some example embodiments of method 2000, generating the plurality of hint combinations 2012 is based at least in part on the event. In example embodiments, the event is a snappi-event.

Further, in some example embodiments of the method 2000, the performance data includes one or more of the timings. In example embodiment, the performance data further includes one or more of the plurality of hint combinations. In some example embodiments, the performance data associates each of the one or more timings to one of the plurality of hint combinations.

Referring to FIG. 20 and the method 2000, in some example embodiments, at least one of the hint combinations includes an ordered set of hints of at least some the plurality of hints. And in some example embodiments, the ordered set of hints is based at least in part on a prefetching priority. In some example embodiments, the ordered set of hints is based at least in part on a network resource. In example embodiments, the ordered set of hints is based at least in part on an expected bandwidth of at least one network connection. In other example embodiments, the ordered set of hints is based at least in part on a compute resource. In example embodiments, the ordered set of hints is based at least in part on an available memory.

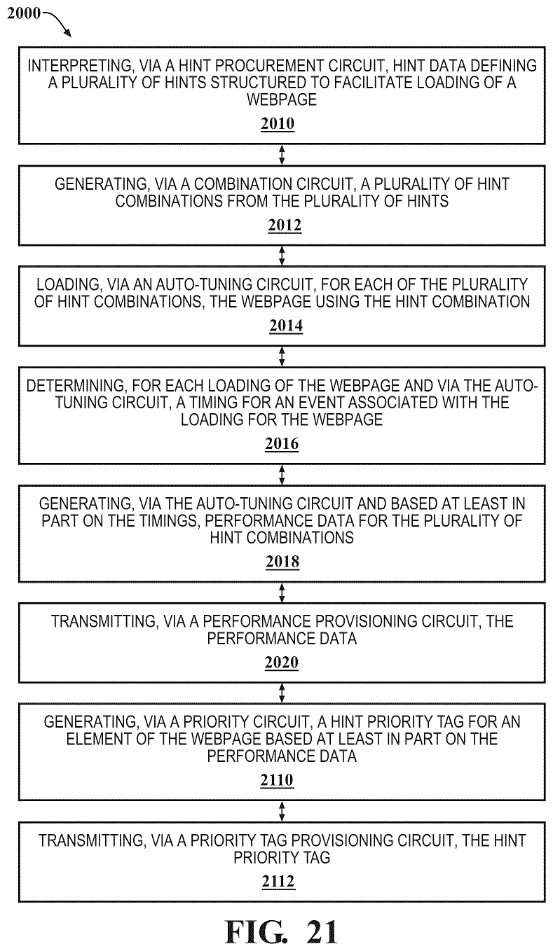

Referring now to FIG. 21, in example embodiments, the method 2000 further includes generating, via a priority circuit, a hint priority tag for an element of the webpage based at least in part on the performance data 2110. Further, the method 2000 may further include transmitting, via a priority tag provisioning circuit, the hint priority tag 2112.

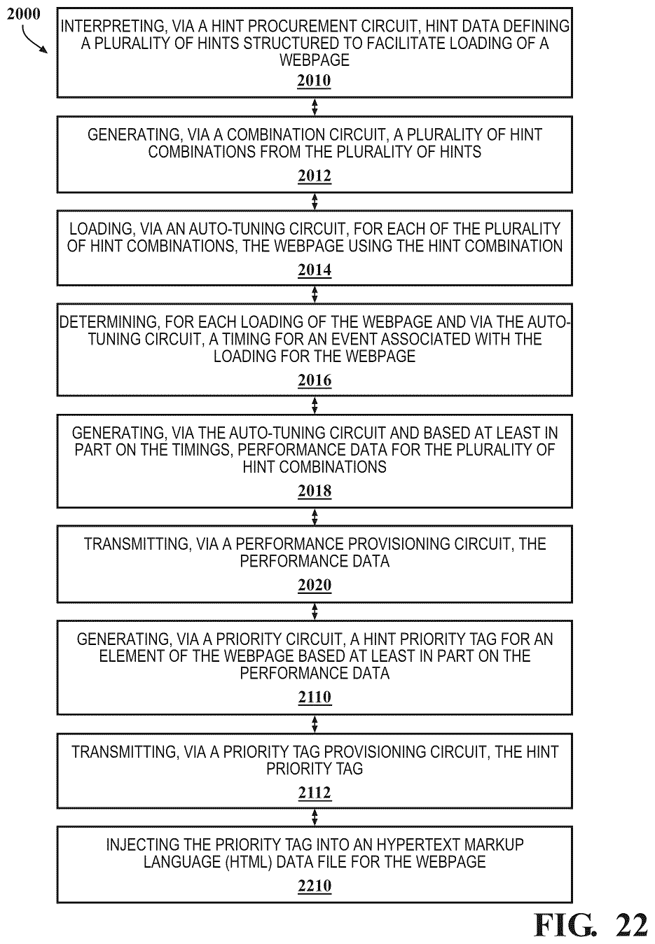

Referring to FIG. 22, in example embodiments, the method 2000 further includes injecting the priority tag into a HyperText Markup Language (HTML) data file for the webpage 2210.

Example embodiments are for a non-transitory computer-readable medium storing instructions that, when loaded into at least one processor, cause the at least one processor to interpret hint data defining a plurality of hints structured to facilitate loading of a webpage. The non-transitory computer-readable medium may generate a plurality of hint combinations from the plurality of hints and load, for each of the plurality of hint combinations, the webpage using the hint combination. Further, the medium may determine, for each loading of the webpage, a timing for an event associated with the loading for the webpage, and generate, based at least in part on the timings, performance data for the plurality of hint combinations. Lastly, the medium may transmit the performance data.

In example embodiments of the non-transitory computer-readable medium, the plurality of hints includes information for locating one or more resources used to load the webpage. Further, in some example embodiments of the medium, the plurality of hints includes one or more child universal resource locators (URLs). In example embodiments of the medium, the one or more resources are elements rendered on the webpage. In some embodiments, the elements are graphics.

In example embodiments of the non-transitory computer-readable medium the event is a largest contentful paint. In some examples, the event is an all contentful paint. In some examples, the event is a first contentful object paint. In some examples, the event is a visual complete. While in some examples, the event is update layout tree.

In example embodiments of the non-transitory computer-readable medium, the stored instructions further cause the at least one processor to generate the plurality of hint combinations based at least in part on the event. In examples, the event is a snappi-event.

In some examples of the non-transitory computer-readable medium the performance data includes one or more of the timings. In some examples of the medium, the performance data further includes one or more of the plurality of hint combinations. In examples, the performance data associates each of the one or more timings to one of the plurality of hint combinations.

In example embodiments of the non-transitory computer-readable medium, at least one of the hint combinations includes an ordered set of hints of at least some the plurality of hints. In some example embodiments, the ordered set of hints is based at least in part on a prefetching priority. In some examples, the ordered set of hints is based at least in part on a network resource. In some examples, the ordered set of hints is based at least in part on an expected bandwidth of at least one network connection. In some embodiments of the medium, the ordered set of hints is based at least in part on a compute resource, and in some examples, the ordered set of hints is based at least in part on an available memory.

In example embodiments of the non-transitory computer-readable medium, the stored instructions further cause the at least one processor to generate a hint priority tag for an element of the webpage based at least in part on the performance data and transmit the hint priority tag.

In example embodiments of the medium, the stored in instructions further cause at least one processor to inject the priority tag into the webpage. In some examples, the stored instructions further cause at least one processor to inject the priority tag into a HyperText Markup Language (HTML) data file for the webpage.

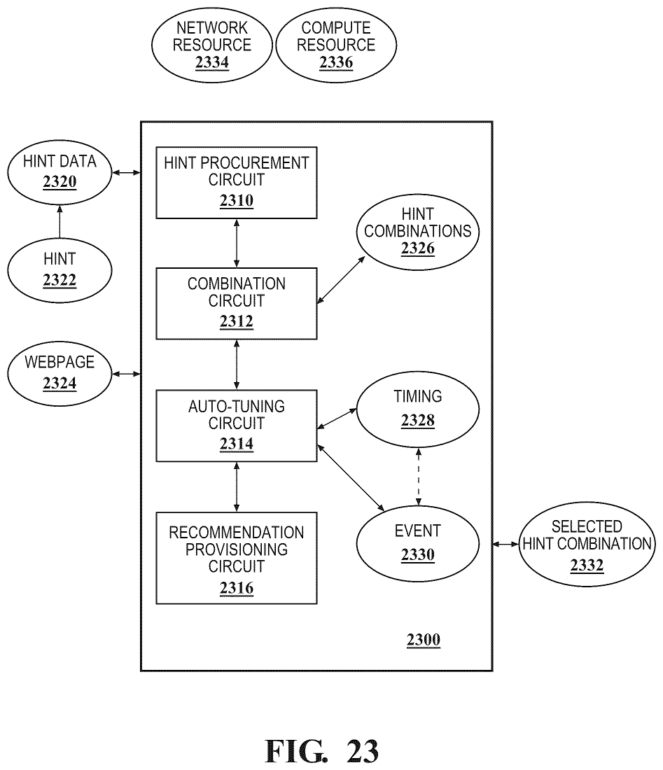

FIG. 23 is an example of an apparatus 2300 that includes a hint procurement circuit 2310, a combination circuit 2312, an autotuning circuit 2314, and a recommendation provisioning circuit 2316. Apparatus 2300 may form part of the discovery servers 110 (FIG. 1), the hint tuning servers 112 (FIG. 1), the webservers 114 (FIG. 1), resource servers 116 and 118 (FIG. 1), and/or any other computing device disclosed herein. The hint procurement circuit 2310 may be structured to interpret hint data 2320 defining a plurality of hints 2322 structured to facilitate loading of a webpage 2324. The combination circuit 2312 may be structured to generate a plurality of hint combinations 2326 from the plurality of hints 2322. The auto-tuning circuit 2314 may be structured to load, for each of the plurality of hint combinations 2326, the webpage 2324 using the hint combination 2326. Further, the auto-tuning circuit 2314 may determine, for each loading of the webpage 2324, a timing 2328 for an event 2330 associated with the loading for the webpage 2324, and the auto-tuning circuit 2314 may select a hint combination 2332 from the plurality of hint combinations 2326 based at least in part on the timings 2328. The recommendation provisioning circuit 2316 may be structured to transmit the selected hint combination 2332.

In embodiments, the auto-tuning circuit 2314 may be further structured to generate the plurality of hint combinations 2326 based at least in part on an expected network resource 2334 associated with the plurality of hints 2322.

In example embodiments, the expected network resource 2334 may include and/or otherwise be based at least in part on at least one of: a bandwidth, a latency, or a cost.

In embodiments, the auto-tuning circuit 2314 may be further structured to generate the plurality of hint combinations 2326 based at least in part on an expected compute resource 2336 associated with the plurality of hints 2322. In example embodiments, the expected compute resource 2336 may include and/or otherwise be based at least in part on at least one of a cache or a processing capability.

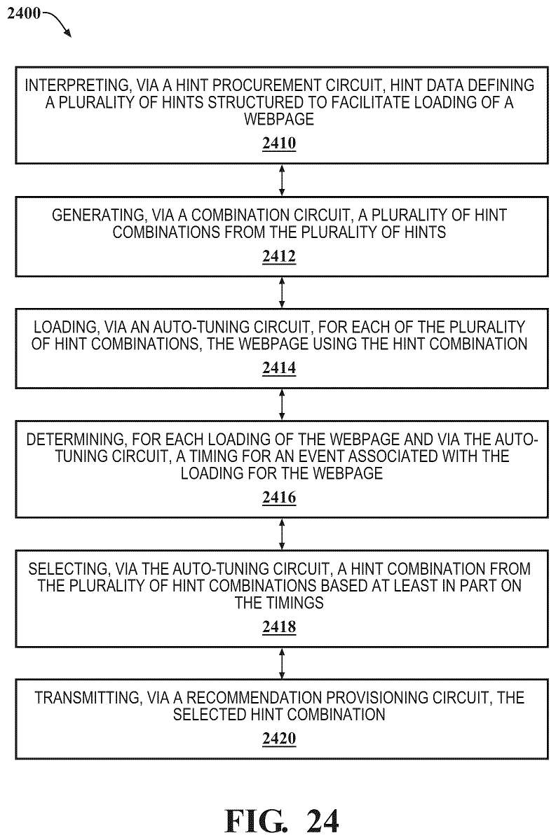

FIG. 24 is an example embodiment of a method 2400 that may be performed via the apparatus 2300 and/or any other computing device disclosed herein. The method 2400 includes interpreting, via a hint procurement circuit, hint data defining a plurality of hints structured to facilitate loading of a webpage 2410. The method 2400 may further include generating, via a combination circuit, a plurality of hint combinations from the plurality of hints 2412, and loading, for each of the plurality of hint combinations and via an auto-tuning circuit, the webpage using the hint combination 2414. The method 2400 may also include determining, for each loading of the webpage and via the auto-tuning circuit, a timing for an event associated with the loading for the webpage 2416, and selecting, via the auto-tuning circuit, a hint combination from the plurality of hint combinations based at least in part on the timings 2418. The method 2400 may also include transmitting, via a recommendation provisioning circuit, the selected hint combination 2420.

In example embodiments, the method 2400 may generate the plurality of hint combinations based at least in part on an expected network resource associated with the plurality of hints. In example embodiments, the expected network resource may be based at least in part on at least one of a bandwidth, a latency, or a cost.

In example embodiments, generating the plurality of hint combinations 2412 may be based at least in part on an expected compute resource associated with the plurality of hints. In example embodiments, the expected compute resource in may be based at least in part on at least one of a cache or a processing capability.

An example embodiment includes a non-transitory computer-readable medium storing instructions that, when loaded into at least one processors, may cause at least one processor to: interpret hint data defining a plurality of hints structured to facilitate loading of a webpage. Further, the non-transitory computer-readable medium may generate a plurality of hint combinations from the plurality of hints and loads, for each of the plurality of hint combinations, the webpage using the hint combination. Also, the medium may determine, for each loading of the webpage, a timing for an event associated with the loading for the webpage and select a hint combination from the plurality of hint combinations based at least in part on the timings. Lastly, the medium may transmit the selected hint combination.

In an example embodiment of the non-transitory computer-readable medium, the stored instructions may further cause at least one processor to generate the plurality of hint combinations based at least in part on an expected network resource associated with the plurality of hints.

In an example embodiment of the non-transitory computer-readable medium, the expected network resource may be based at least in part on at least one of a bandwidth, a latency, or a cost.

In an example embodiment of the non-transitory computer-readable medium, the stored instructions may be further structured to generate the plurality of hint combinations based at least in part on an expected compute resource associated with the plurality of hints.

In an example embodiment of the non-transitory computer-readable medium, the expected compute resource is based at least in part on at least one of a cache or a processing capability.

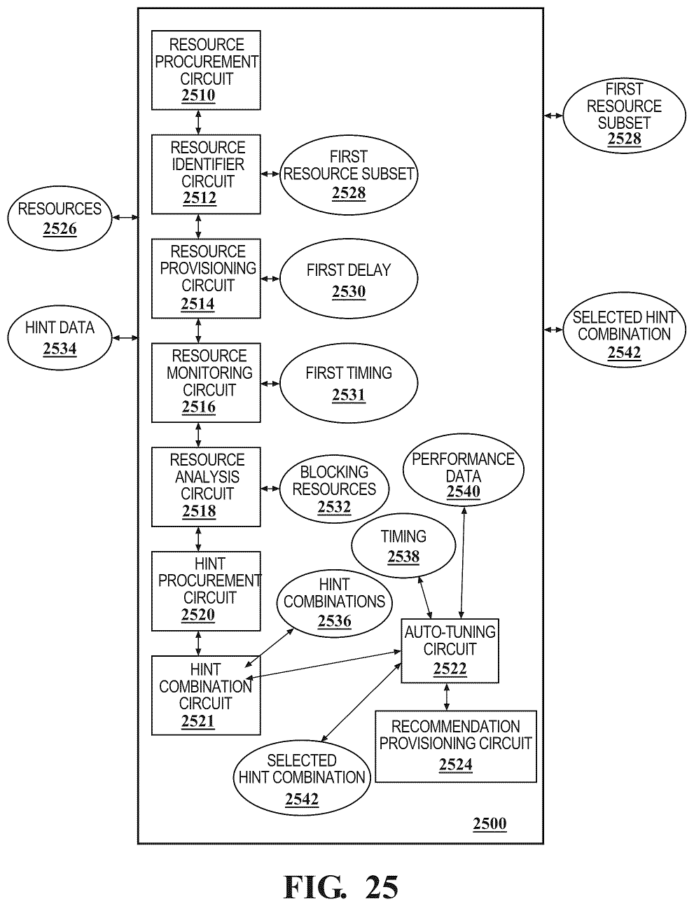

FIG. 25 depicts an apparatus 2500 that combines aspects of identifying essential resources and auto-tuning hints to expediate their loading, in accordance with embodiments of the current disclosure. The apparatus 2500 may form part of the discovery servers 110 (FIG. 1), the hint tuning servers 112 (FIG. 1), the webservers 114 (FIG. 1), resource servers 116 and 118 (FIG. 1), and/or any other computing device disclosed herein. The apparatus 2500 may include a resource procurement circuit 2510, a resource identifier circuit 2512, a resource provisioning circuit 2514, a resource monitoring circuit 2516, a resource analysis circuit 2518, a hint procurement circuit 2520, a hint combination circuit 2521, an auto-tuning circuit 2522, and/or a recommendation circuit 2524.

The resource procurement circuit 2510 is structured to interpret a set of resources 2526 for a webpage, and the resource identifier circuit 2512 is structured to select a first subset 2528 of resources from the set of resources 2526. The resource provisioning circuit 2514 is structured to transmit the set of resources 2526 to a webpage browser, where the first subset of resources 2528 is transmitted to the webpage browser after a first delay 2530. The resource monitoring circuit 2516 is structured to: monitor a first execution of the webpage browser that uses the set of resources 2526 to load the webpage, and determine a first timing 2531 of an event during the first execution. The resource analysis circuit 2518 is structured to determine, based at least in part on the first timing 2531 and the first delay 2530, one or more blocking resources 2532, in the set of resources 2526, for the event. The hint procurement circuit 2520 is structured to interpret hint data 2534 defining a plurality of hints structured to facilitate prefetching of the one or more blocking resources 2532 as part of loading of the webpage, and the combination circuit 2521 is structured to generate a plurality of hint combinations 2536 from the plurality of hints. An auto-tuning circuit 2522 is structured to: load, for each of the plurality of hint combinations, the webpage using the webpage browser and the hint combination 2536; determine, for each loading of the webpage, a timing 2538 for an event associated with the loading for the webpage; generate, based at least in part on the timings 2538, performance data 2540 for the plurality of hint combinations 2536; and select a hint combination 2542 from the plurality of hint combinations 2536 based at least in part on the timings 2538. The recommendation provisioning circuit 2524 is structured to transmit the selected hint combination 2542.

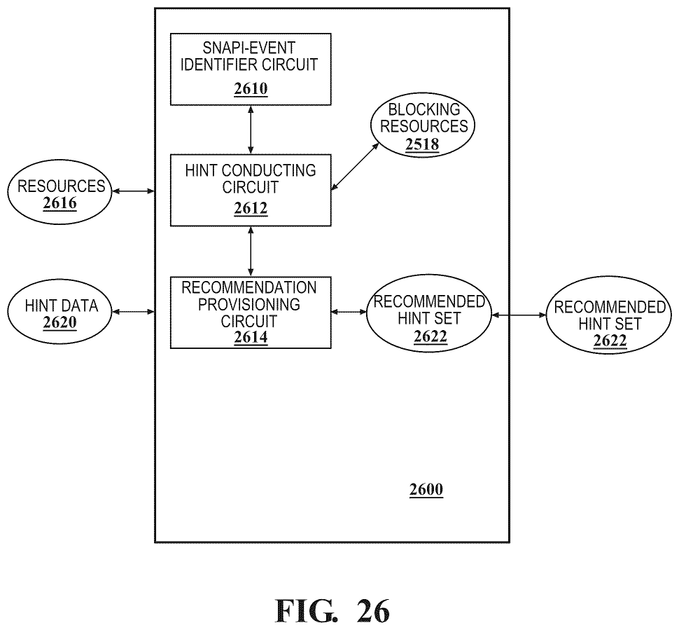

FIG. 26 depicts a system 2600 that combines aspects of identifying essential resources and auto-tuning hints to expediate their loading, in accordance with embodiments of the current disclosure. The system 2600 includes a snappi-event identifier circuit 2610, a hint conducting circuit 2612, and a recommendation provisioning circuit 2614, one or more of which may form part of the discovery servers 110 (FIG. 1), the hint tuning servers 112 (FIG. 1), the webservers 114 (FIG. 1), resource servers 116 and 118 (FIG. 1), and/or any other computing device disclosed herein.

The snappi-event identifier circuit 2610 is structured to interpret a set of resources 2616 for a webpage and determine one or more blocking resources 2618. The hint conducting circuit 2612 is structured to: interpret data defining a plurality of hints 2620 structured to facilitate prefetching of the one or more blocking resources 2532 as part of loading webpage; and generate a recommended hint set 2622 for one or more of the plurality of hints 2620. The recommendation provisioning circuit 2614 is structured to transmit the recommended hint set 2622.

Embodiments disclosed herein further include systems and methods for mapping results from exhaustive hint testing into actionable rules. After testing various hint combinations in a simulated environment to identify those that maximize page load performance, these optimized configurations are distilled into rules. These rules allow the browser or optimization system to apply only the most effective hints for each unique page type or URL. This simplification not only streamlines the decision-making process but also ensures that optimized hints are applied in real-world scenarios without requiring extensive computational resources to re-evaluate all hint combinations.

To facilitate this process, a binary tree structure is utilized, which enables rapid determination of the optimal hint combination based on specific page characteristics, such as the page type or URL pattern. By organizing the hint selection process within a binary tree, the system can quickly navigate through potential hint configurations, selecting the most effective set for a given page structure or user scenario.

In some instances, a webpage may include hints that conflict with the optimized set of hints determined by the embodiments described herein. In some cases, developers may include hints in webpages with HTML tags, HTTP headers, and JavaScript to provide browsers with instructions on how to handle specific resources during page load. Developer-defined hints, while intended to accelerate page loading, can sometimes conflict with the system's optimized hint configurations. This conflict may result in redundant or suboptimal loading behaviors, as the developer-specified hints may not account for real-time conditions or specific page characteristics. By programmatically removing or modifying these developer hints, the system ensures that only the most effective, context-aware hints are active during a page load.

In embodiments, API calls can be used as a direct method to control the application of hints by communicating with the content delivery network (CDN) or server infrastructure. For example, API endpoints may enable the system to override hints that are already embedded in the server response. This allows the system to selectively deactivate certain hints that could otherwise slow down page loading or result in unnecessary resource consumption.

Modification of existing webpage hints may include injecting JavaScript into the page. JavaScript injections enable the system to dynamically modify or remove existing hints within the browser's document object model (DOM) and can be used when dealing with static HTML where the hints are hard-coded and cannot be altered by server-side configurations. By injecting scripts that control the application or priority of hints, the system can fine-tune resource loading at the browser level, ensuring that critical resources are prioritized according to the most current conditions and optimizations.

The system may also modify the HTML code directly, particularly for persistent hints embedded in the HTML headers or body. This method involves rewriting the HTML to remove, alter, or reprioritize certain hints before the page is fully rendered by the browser. By modifying the HTML structure, the system can remove unnecessary prefetch or preload links that might otherwise overload the network or delay other essential elements from loading.

Method for identifying hints in pages, comparing against the list of optimized hints and generating instruction to modify the hints. The instructions can be sent to a CDN server.

One or more certain further aspects of the example systems, apparatuses, and methods are described following, any one or more of which may be incorporated in certain embodiments.

Clause 1. An apparatus comprising: a resource procurement circuit structured to interpret a set of resources; a resource identifier circuit structured to select a first subset of resources from the set of resources; a resource provisioning circuit structured to transmit the set of resources to an application, wherein the first subset of resources is transmitted to the application after a first delay; a resource monitoring circuit structured to: monitor a first execution of the application that uses the set of resources, and determine a first timing of an event during the first execution; a resource analysis circuit structured to determine, based at least in part on the first timing and the first delay, one or more blocking resources, in the set of resources, for the event; and an analysis provisioning circuit structured to transmit a message comprising an indicator that identifies the one or more blocking resources.

Clause 2. The apparatus of clause 1, wherein the application is a webpage browser.

Clause 3. The apparatus of clause 2 further comprising: a memory device; and a collection circuit; wherein: the set of resources are for a webpage; the collection circuit is structured to collect resources for the webpage for the set of resources and store the set of resources and the webpage in the memory device; and the resource procurement circuit is further structured to retrieve the set of resources from the memory device.

Clause 4. The apparatus of clause 1, wherein the event is a largest contentful paint.

Clause 5. The apparatus of clause 1, wherein the event is an all contentful paint.

Clause 6. The apparatus of clause 1, wherein the event is a first contentful object paint.

Clause 7. The apparatus of clause 1, wherein the event is a paint event.

Clause 8. The apparatus of clause 1, wherein the event is a visual complete.

Clause 9. The apparatus of clause 1, wherein the event is update layout tree.

Clause 10. The apparatus of clause 1, wherein the event is a snappi-event.

Clause 11. The apparatus of clause 10 further comprising: a snappiness circuit structured to identify the snappi-event by analyzing a second execution of the application using the set of resources.

Clause 12. The apparatus of clause 1, wherein the one or more blocking resources are required for the event to complete.

Clause 13. The apparatus of clause 1 further comprising: a baseline procurement circuit structured to interpret a timing baseline for the event; wherein the resource analysis circuit is further structured to determine the one or more blocking resources based at least in part on the timing baseline.

Clause 14. The apparatus of clause 13, wherein the resource analysis circuit is further structured to determine the one or more blocking resources based at least in part on the first timing being longer than an expected timing for the event defined by the timing baseline.

Clause 15. The apparatus of clause 1, wherein the resource analysis circuit comprises: a Central Processing Unit (CPU) monitoring circuit structured to: monitor a CPU on which at least part of the first execution of the application occurs; and determine that at least one of the first subset of resources blocks the at least a part of the first execution on the CPU; wherein the resource analysis circuit is further structured to determine the one or more blocking resources based at least in part on the determination that the at least one of the first subset of resources blocks the at least a part of the first execution on the CPU.

Clause 16. The apparatus of clause 1, wherein: the resource identifier circuit is further structured to select a second subset of resources from the set of resources; the resource provisioning circuit is further structured to re-transmit the set of resources to the application, wherein the second subset of resources is re-transmitted to the application after a second delay; the resource monitoring circuit is further structured to: monitor a second execution of the application using the set of resources, and determine a second timing of the event during the second execution; and the resource analysis circuit is further structured to determine the one or more blocking resources further based at least in part on the second timing and the second delay.

Clause 17. The apparatus of clause 16, wherein the one or more blocking resources includes resources in the first subset of resources and the second subset of resources.

Clause 18. The apparatus of clause 16, wherein the resource analysis circuit is further structured to compare the first timing to the second timing, wherein: the one or more blocking resources includes resources in the first subset of resources when the first timing is longer than the second timing; and the one or more blocking resources includes resources in the second subset of resources when the second timing is longer than the first timing.

Clause 19. A method comprising: interpreting, via a resource procurement circuit, a set of resources; selecting, via a resource identifier circuit, a first subset of resources from the set of resources; transmitting, via a resource provisioning circuit, the set of resources to an application, wherein the first subset of resources is transmitted to the application after a first delay; monitoring, via resource monitoring circuit, a first execution of the application that uses the set of resources; determining, via resource monitoring circuit, a first timing of an event during the first execution; determining, via a resource analysis circuit and based at least in part on the first timing and the first delay, one or more blocking resources, in the set of resources, for the event; and transmitting, via an analysis provisioning circuit, a message comprising an indicator that identifies the one or more blocking resources.

Clause 20. The method of clause 19, wherein the application is a webpage browser.

Clause 21. The method of clause 20, wherein: the set of resources are for a webpage; and the method further comprises: collecting, via a collection circuit, the set of resources for the webpage; storing, via the collection circuit, the set of resources and the webpage in a memory device; and retrieving, via the resource procurement circuit, the set of resources from the memory device.

Clause 22. The method of clause 19, wherein the event is a largest contentful paint.

Clause 23. The method of clause 19, wherein the event is an all contentful paint.

Clause 24. The method of clause 19, wherein the event is a paint event.

Clause 25. The method of clause 19, wherein the event is a first contentful object paint.

Clause 26. The method of clause 19, wherein the event is a visual complete.

Clause 27. The method of clause 19, wherein the event is update layout tree.

Clause 28. The method of clause 19, wherein the event is a snappi-event.

Clause 29. The method of clause 28 further comprising: identifying, via a snappiness circuit, the snappi-event by analyzing a second execution of the application using the set of resources.

Clause 30. The method of clause 19, wherein the one or more blocking resources are required for the event to complete.

Clause 31. The method of clause 19 further comprising: interpreting, via a baseline procurement circuit, a timing baseline for the event; wherein, determining, via the resource analysis circuit, the one or more blocking resources is further based at least in part on the timing baseline.

Clause 32. The method of clause 31, wherein determining, via the resource analysis circuit, the one or more blocking resources is further based at least in part on the first timing being longer than an expected timing for the event defined by the timing baseline.

Clause 33. The method of clause 19 further comprising: monitoring, via a Central Processing Unit (CPU) monitoring circuit, a CPU on which at least part of the first execution of the application occurs; and determining, via the CPU monitoring circuit, that at least one of the first subset of resources blocks the at least a part of the first execution on the CPU; wherein determining, via the resource analysis circuit, the one or more blocking resources is based at least in part on the determination that the at least one of the first subset of resources blocks the at least a part of the first execution on the CPU.

Clause 34. The method of clause 19 further comprising: selecting, via the resource identifier circuit, a second subset of resources from the set of resources; re-transmitting, via the resource provisioning circuit, the set of resources to the application, wherein the second subset of resources is re-transmitted to the application after a second delay; monitoring, via the resource monitoring circuit, a second execution of the application using the set of resources; and determining, via the resource monitoring circuit, a second timing of the event during the second execution; wherein determining, via the resource analysis circuit, the one or more blocking resources is further based at least in part on the second timing and the second delay.

Clause 35. The method of clause 34, wherein the one or more blocking resources includes resources in the first subset of resources and the second subset of resources.

Clause 36. The method of clause 34 further comprising: comparing, via the resource analysis circuit, the first timing to the second timing, wherein: the one or more blocking resources includes resources in the first subset of resources when the first timing is longer than the second timing; and the one or more blocking resources includes resources in the second subset of resources when the second timing is longer than the first timing.

Clause 37. A non-transitory computer-readable medium storing instructions that, when loaded into at least one processor, cause the at least one processor to: interpret a set of resources; select a first subset of resources from the set of resources; transmit the set of resources to an application, wherein the first subset of resources is transmitted to the application after a first delay; monitor a first execution of the application that uses the set of resources; determine a first timing of an event during the first execution; determine, based at least in part on the first timing and the first delay, one or more blocking resources, in the set of resources, for the event; and transmit a message comprising an indicator that identifies the one or more blocking resources.

Clause 38. The non-transitory computer-readable medium of clause 37, wherein the application is a webpage browser.

Clause 39. The non-transitory computer-readable medium of clause 38, wherein: the set of resources are for a webpage; and the stored instructions are further structured to cause the at least one processor to: collect the set of resources; store the set of resources and the webpage in a memory device; and retrieve the set of resources from the memory device.

Clause 40. The non-transitory computer-readable medium of clause 37, wherein the event is a largest contentful paint.

Clause 41. The non-transitory computer-readable medium of clause 37, wherein the event is an all contentful paint.

Clause 42. The non-transitory computer-readable medium of clause 37, wherein the event is a paint event.

Clause 43. The non-transitory computer-readable medium of clause 37, wherein the event is a first contentful object paint.

Clause 44. The non-transitory computer-readable medium of clause 37, wherein the event is a visual complete.

Clause 45. The non-transitory computer-readable medium of clause 37, wherein the event is update layout tree.

Clause 46. The non-transitory computer-readable medium of clause 37, wherein the event is a snappi-event.

Clause 47. The non-transitory computer-readable medium of clause 46, wherein the stored instructions further cause the at least one processor to: identify the snappi-event by analyzing a second execution of the application using the set of resources.

Clause 48. The non-transitory computer-readable medium of clause 37, wherein the one or more blocking resources are required for the event to complete.

Clause 49. The non-transitory computer-readable medium of clause 37, wherein the stored instructions further cause the at least one processor to: interpret a timing baseline for the event; wherein the determination of the one or more blocking resources is further based at least in part on the timing baseline.

Clause 50. The non-transitory computer-readable medium of clause 49, wherein the determination of the one or more blocking resources is further based at least in part on the first timing being longer than an expected timing for the event defined by the timing baseline.

Clause 51. The non-transitory computer-readable medium of clause 37, wherein the stored instructions further cause the at least one processor to: monitor a central processing unit (CPU) on which at least part of the first execution of the application occurs; and determine that at least one of the first subset of resources blocks the at least a part of the first execution on the CPU; wherein the determination of the one or more blocking resources is based at least in part on the determination that the at least one of the first subset of resources blocks the at least a part of the first execution on the CPU.

Clause 52. The non-transitory computer-readable medium of clause 37, wherein the stored instructions further cause the at least one processor to: select a second subset of resources from the set of resources; re-transmit the set of resources to the application, wherein the second subset of resources is re-transmitted to the application after a second delay; monitor a second execution of the application using the set of resources; and determine a second timing of the event during the second execution; wherein the determination of the one or more blocking resources is further based at least in part on the second timing and the second delay.

Clause 53. The non-transitory computer-readable medium of clause 52, wherein the one or more blocking resources includes resources in the first subset of resources and the second subset of resources.

Clause 55. An apparatus comprising: a resource procurement circuit structured to load a first set of resources for consumption by a first application; a resource provisioning circuit structured to provide the first set of resources for the first application; a resource monitoring circuit structured to monitor a first execution of the first application with the first set of resources; a timing circuit structured to determine a first timing of an event during the first execution; wherein: the resource procurement circuit is further structured to load a second set of resources and a third set of resources for consumption by the first application, wherein the second set of resources is a subset of the first set of resources, the third set of resources is a different subset of the first set of resources; the resource provisioning circuit is further structured to provide, at a first time, the second set of resources for the first application; the resource monitoring circuit is further structured to monitor a second execution of the first application with the second set of resources; the resource provisioning circuit is further structured to provide, at a second time, the third set of resources for the first application; the resource monitoring circuit is further structured to monitor a third execution of the first application with the third set of resources; the timing circuit is further structured to determine a second timing of the event during the second execution and the third execution; wherein the apparatus further comprises: a resource analysis circuit structured to determine, from the second timing, that the third set of resources includes resources that are required for the event; and an analysis provisioning circuit structured to transmit a message comprising an indication that identifies the third set of resources as including the resources as being required for the event.

Clause 56. The apparatus of clause 55, wherein the application is a webpage browser.

Clause 57. The apparatus of clause 55, wherein the event is a largest contentful paint.

Clause 58. The apparatus of clause 55, wherein the event is an all contentful paint.

Clause 59. The apparatus of clause 55, wherein the event is a paint event.

Clause 60. The apparatus of clause 55, wherein the event is a first contentful object paint.

Clause 61. The apparatus of clause 55, wherein the event is a visual complete.

Clause 62. The apparatus of clause 55, wherein the event is update layout tree.

Clause 63. The apparatus of clause 55, wherein the event is a snappi-event.

Clause 64. A method comprising: loading a first set of resources for consumption by a first application; providing the first set of resources for the first application; monitoring a first execution of the first application with the first set of resources; determining a first timing of an event during the first execution; loading a second set of resources and a third set of resources for consumption by the first application, wherein the second set of resources is a subset of the first set of resources, the third set of resources is a different subset of the first set of resources; providing, at a first time, the second set of resources for the first application; monitoring a second execution of the first application with the second set of resources; providing, at a second time, the third set of resources for the first application; monitoring a third execution of the first application with the third set of resources; determining a second timing of the event during the second execution and the third execution; and determining, from the second timing, that the third set of resources includes resources that are required for the event.

Clause 65. The method of clause 64, wherein the application is a webpage browser.

Clause 66. The method of clause 64, wherein the event is a largest contentful paint.

Clause 67. The method of clause 64, wherein the event is an all contentful paint.

Clause 68. The method of clause 64, wherein the event is a paint event.

Clause 69. The method of clause 64, wherein the event is a first contentful object paint.

Clause 70. The method of clause 64, wherein the event is a visual complete.

Clause 71. The method of clause 64, wherein the event is update layout tree.

Clause 72. The method of clause 64, wherein the event is a snappi-event.

Clause 73. An apparatus comprising: a resource procurement circuit structured to load a first set of resources; a selection circuit structured to select, from the first set of resources, a second set of resources and a third set of resources, wherein the second set of resources is a subset of the first set of resources, the third set of resources is a different subset of the first set of resources; a resource provisioning circuit structured to provide, at a first time, the second set of resources for a first application; a resource monitoring circuit structured to monitor a first execution of the first application with the second set of resources; wherein the resource provisioning circuit is further structured to provide, at a second time, the third set of resources for the first application; wherein the resource monitoring circuit is further structured to monitor a second execution of the first application with the third set of resources; wherein the apparatus further comprises: a timing circuit structured to determine a timing of an event during the first execution and the second execution; and a resource analysis circuit structured to determine, based on the first time, the second time, and the timing, that the third set of resources includes resources that are required for the event.

Clause 74. The apparatus of clause 73, wherein the application is a webpage browser.

Clause 75. The apparatus of clause 73, wherein the event is a largest contentful paint.

Clause 76. The apparatus of clause 73, wherein the event is an all contentful paint.

Clause 77. The apparatus of clause 73, wherein the event a paint event.

Clause 78. The apparatus of clause 73, wherein the event is a first contentful object paint.

Clause 79. The apparatus of clause 73, wherein the event is a visual complete.

Clause 80. The apparatus of clause 73, wherein the event is update layout tree.

Clause 81. The apparatus of clause 73, wherein the event is a snappi-event.

Clause 82. A method comprising: loading a first set of resources; selecting, from the first set of resources, a second set of resources and a third set of resources, wherein the second set of resources is a subset of the first set of resources, the third set of resources is a different subset of the first set of resources; providing, at a first time, the second set of resources for a first application; monitoring a first execution of the first application with the second set of resources; providing, at a second time, the third set of resources for the first application; monitoring a second execution of the first application with the third set of resources; determining a timing of an event during the first execution and the second execution; and determining, based on the first time, the second time, and the timing, that the third set of resources includes resources that are required for the event.

Clause 83. The method of clause 82, wherein the application is a webpage browser.

Clause 84. The method of clause 82, wherein the event is a largest contentful paint.

Clause 85. The method of clause 82, wherein the event is an all contentful paint.

Clause 86. The method of clause 82, wherein the event is a paint event.

Clause 87. The method of clause 82, wherein the event is a first contentful object paint.

Clause 88. The method of clause 82, wherein the event is a visual complete.

Clause 89. The method of clause 82, wherein the event is update layout tree.

Clause 90. The method of clause 82, wherein the event is a snappi-event.

Clause 91. An apparatus comprising: a resource procurement circuit structured to interpret a set of resources; a resource identifier circuit structured to select, from the set of resources, a first subset of resources; a resource provisioning circuit structured to transmit the set of resources to an application, wherein the first subset of resources are transmitted after a first delay; a resource monitoring circuit structured to: monitor a first execution of the application; and monitor one or more paint events for one or more areas of a page; a resource analysis circuit structured to: determine a timeline of the one or more paint events; and determine, based on the timeline and the first delay, that the first subset of resources includes one or more blocking resources for the event; and an analysis provisioning circuit structured to transmit a message comprising an indicator that identifies the one or more blocking resources.

Clause 92. The apparatus of clause 91, wherein the application is a webpage browser.

Clause 93. The apparatus of clause 92 further comprising: a memory device; and a collection circuit; wherein: the set of resources are for a webpage; the collection circuit is structured to collect the set of resources for the webpage and store the set of resources and the webpage in the memory device; and the resource procurement circuit is further structured to retrieve the set of resources from the memory device.

Clause 94. A method comprising: interpreting, via a resource procurement circuit, a set of resources; selecting, via a resource identifier circuit, from the set of resources, a first subset of resources; transmitting, via a resource provisioning circuit, the set of resources to an application, wherein the first subset of resources are transmitted after a first delay; monitoring, via a resource monitoring circuit, a first execution of the application; monitoring, via the resource monitoring circuit, one or more paint events for one or more areas of a page; determining, via a resource analysis circuit, a timeline of the one or more paint events; and determining, via the resource analysis circuit and based on the timeline and the first delay, that the first subset of resources includes one or more blocking resources for the event; and transmitting, via an analysis provisioning circuit, a message comprising an indicator that identifies the one or more blocking resources.

Clause 95. The method of clause 94, wherein the application is a webpage browser.

Clause 96. The method of clause 95 wherein: the set of resources are for a webpage; and the method further comprises: collecting, via a collection circuit, the set of resources; storing, via the collection circuit, the set of resources and the webpage in a memory device; and retrieving, via the resource procurement circuit, the set of resources from the memory device.

Clause 97. An apparatus comprising: a hint procurement circuit structured to interpret hint data defining a plurality of hints structured to facilitate loading of a webpage; a combination circuit structured to generate a plurality of hint combinations from the plurality of hints; an auto-tuning circuit structured to: load, for each of the plurality of hint combinations, the webpage using the hint combination; determine, for each loading of the webpage, a timing for an event associated with the loading for the webpage; and generate, based at least in part on the timings, performance data for the plurality of hint combinations; and a performance provisioning circuit structured to transmit the performance data.

Clause 98. The apparatus of clause 97, wherein the plurality of hints comprises information for locating one or more resources used to load the webpage.

Clause 99. The apparatus of clause 98, wherein the plurality of hints comprises one or more child universal resource locators (URLs).

Clause 100. The apparatus of clause 99, wherein the one or more resources are elements rendered on the webpage.

Clause 101. The apparatus of clause 100, wherein the elements are graphics.

Clause 102. The apparatus of clause 97, wherein the plurality of hints comprises at least one of: a preconnnect hint; a preload hint; or a priority hint.

Clause 103. The apparatus of clause 97, wherein the plurality of hints comprises at least one early hint.

Clause 104. The apparatus of clause 97, wherein the plurality of hints comprises at least one late hint.

Clause 105. The apparatus of clause 97, wherein the event is a largest contentful paint.

Clause 106. The apparatus of clause 97, wherein the event is an all contentful paint.

Clause 107. The apparatus of clause 97, wherein the event is a paint event.

Clause 108. The apparatus of clause 97, wherein the event is a first contentful object paint.

Clause 109. The apparatus of clause 97, wherein the event is a visual complete.

Clause 110. The apparatus of clause 97, wherein the event is update layout tree.

Clause 111. The apparatus of clause 97, wherein the combination circuit is further structured to generate the plurality of hint combinations based at least in part on the event.

Clause 112. The apparatus of clause 111, wherein the event is a snappi-event.

Clause 113. The apparatus of clause 97, wherein the performance data comprises one or more of the timings.

Clause 114. The apparatus of clause 113, wherein the performance data further comprises one or more of the plurality of hint combinations.

Clause 115. The apparatus of clause 114, wherein the performance data associates each of the one or more timings to one of the plurality of hint combinations.

Clause 116. The apparatus of clause 97, wherein at least one of the hint combinations comprises an ordered set of hints of at least some the plurality of hints.

Clause 117. The apparatus of clause 116, wherein the ordered set of hints is based at least in part on a prefetching priority.

Clause 118. The apparatus of clause 116, wherein the ordered set of hints is based at least in part on a network resource.

Clause 119. The apparatus of clause 116, wherein the ordered set of hints is based at least in part on an expected bandwidth of at least one network connection.

Clause 120. The apparatus of clause 116, wherein the ordered set of hints is based at least in part on a compute resource.

Clause 121. The apparatus of clause 116, wherein the ordered set of hints is based at least in part on an available memory.

Clause 122. The apparatus of clause 97 further comprising: a priority circuit structured to generate a hint priority tag for an element of the webpage based at least in part on the performance data; and a priority tag provisioning circuit structured to transmit the hint priority tag.

Clause 123. The apparatus of clause 122 further comprising: an annotation circuit structured to inject the hint priority tag into the webpage.

Clause 124. The apparatus of clause 123, wherein the priority tag is structured to be injected into a HyperText Markup Language (HTML) data file for the webpage.

Clause 125. A method comprising: interpreting, via a hint procurement circuit, hint data defining a plurality of hints structured to facilitate loading of a webpage; generating, via a combination circuit, a plurality of hint combinations from the plurality of hints; loading, via an auto-tuning circuit, for each of the plurality of hint combinations, the webpage using the hint combination; determining, for each loading of the webpage and via the auto-tuning circuit, a timing for an event associated with the loading for the webpage; generating, via the auto-tuning circuit and based at least in part on the timings, performance data for the plurality of hint combinations; and transmitting, via a performance provisioning circuit, the performance data.

Clause 126. The method of clause 125, wherein the plurality of hints comprises information for locating one or more resources used to load the webpage.

Clause 127. The method of clause 126, wherein the plurality of hints comprises one or more child universal resource locators (URLs).

Clause 128. The method of clause 127, wherein the one or more resources are elements rendered on the webpage.

Clause 129. The method of clause 125, wherein the plurality of hints comprises at least one of: a preconnnect hint; a preload hint; or a priority hint.

Clause 130. The method of clause 125, wherein the plurality of hints comprises at least one early hint.

Clause 131. The method of clause 125, wherein the plurality of hints comprises at least one late hint.

Clause 132. The method of clause 128, wherein the elements include graphics.

Clause 133. The method of clause 125, wherein the event is a largest contentful paint.

Clause 134. The method of clause 125, wherein the event is an all contentful paint.

Clause 135. The method of clause 125, wherein the event is a paint event.

Clause 136. The method of clause 125, wherein the event is a first contentful object paint.

Clause 137. The method of clause 125, wherein the event is a visual complete.

Clause 138. The method of clause 125, wherein the event is update layout tree.

Clause 139. The method of clause 125, wherein generating the plurality of hint combinations is based at least in part on the event.

Clause 140. The method of clause 139, wherein the event is a snappi-event.

Clause 141. The method of clause 125, wherein the performance data comprises one or more of the timings.

Clause 142. The method of clause 141, wherein the performance data further comprises one or more of the plurality of hint combinations.

Clause 143. The method of clause 142, wherein the performance data associates each of the one or more timings to one of the plurality of hint combinations.

Clause 144. The method of clause 125, wherein at least one of the hint combinations comprises an ordered set of hints of at least some the plurality of hints.

Clause 145. The method of clause 144, wherein the ordered set of hints is based at least in part on a prefetching priority.

Clause 146. The method of clause 144, wherein the ordered set of hints is based at least in part on a network resource.

Clause 147. The method of clause 144, wherein the ordered set of hints is based at least in part on an expected bandwidth of at least one network connection.

Clause 148. The method of clause 144, wherein the ordered set of hints is based at least in part on a compute resource.

Clause 149. The method of clause 144, wherein the ordered set of hints is based at least in part on an available memory.

Clause 150. The method of clause 125 further comprising: generating, via a priority circuit, a hint priority tag for an element of the webpage based at least in part on the performance data; and transmitting, via a priority tag provisioning circuit, the hint priority tag.

Clause 151. The method of clause 150 further comprising: an annotation circuit structured to inject the priority tag into the webpage.

Clause 152. The method of clause 151 further comprising: injecting the priority tag into a HyperText Markup Language (HTML) data file for the webpage.

Clause 153. A non-transitory computer-readable medium storing instructions that, when loaded into at least one processor, cause the at least one processor to: interpret hint data defining a plurality of hints structured to facilitate loading of a webpage; generate a plurality of hint combinations from the plurality of hints; load, for each of the plurality of hint combinations, the webpage using the hint combination; determine, for each loading of the webpage, a timing for an event associated with the loading for the webpage; generate, based at least in part on the timings, performance data for the plurality of hint combinations; and transmit the performance data.

Clause 154. The non-transitory computer-readable medium of clause 153, wherein the plurality of hints comprises information for locating one or more resources used to load the webpage.

Clause 155. The non-transitory computer-readable medium of clause 154, wherein the plurality of hints comprises one or more child universal resource locators (URLs).

Clause 156. The non-transitory computer-readable medium of clause 155, wherein the one or more resources are elements rendered on the webpage.

Clause 157. The non-transitory computer-readable medium of clause 156, wherein the elements are graphics.

Clause 158. The non-transitory computer-readable medium of clause 154, wherein the event is a largest contentful paint.

Clause 159. The non-transitory computer-readable medium of clause 154, wherein the event is an all contentful paint.

Clause 160. The non-transitory computer-readable medium of clause 154, wherein the event is a first contentful object paint.

Clause 161. The non-transitory computer-readable medium of clause 154, wherein the event is a visual complete.

Clause 162. The non-transitory computer-readable medium of clause 154, wherein the event is update layout tree.

Clause 163. The non-transitory computer-readable medium of clause 154, wherein the stored instructions further cause the at least one processor to generate the plurality of hint combinations based at least in part on the event.

Clause 164. The non-transitory computer-readable medium of clause 163, wherein the event is a snappi-event.

Clause 165. The non-transitory computer-readable medium of clause 154, wherein the performance data comprises one or more of the timings.

Clause 166. The non-transitory computer-readable medium of clause 165, wherein the performance data further comprises one or more of the plurality of hint combinations.

Clause 167. The non-transitory computer-readable medium of clause 166, wherein the performance data associates each of the one or more timings to one of the plurality of hint combinations.

Clause 168. The non-transitory computer-readable medium of clause 154, wherein at least one of the hint combinations comprises an ordered set of hints of at least some the plurality of hints.

Clause 169. The non-transitory computer-readable medium of clause 168, wherein the ordered set of hints is based at least in part on a prefetching priority.

Clause 170. The non-transitory computer-readable medium of clause 168, wherein the ordered set of hints is based at least in part on a network resource.

Clause 171. The non-transitory computer-readable medium of clause 168, wherein the ordered set of hints is based at least in part on an expected bandwidth of at least one network connection.

Clause 172. The non-transitory computer-readable medium of clause 168, wherein the ordered set of hints is based at least in part on a compute resource.

Clause 173. The non-transitory computer-readable medium of clause 168, wherein the ordered set of hints is based at least in part on an available memory.

Clause 174. The non-transitory computer-readable medium of clause 154, wherein the stored instructions further cause the at least one processor to: generate a hint priority tag for an element of the webpage based at least in part on the performance data; and transmit the hint priority tag.

Clause 175. The non-transitory computer-readable medium of clause 174, wherein the stored in instructions further cause the at least one processor to inject the priority tag into the webpage.

Clause 176. The non-transitory computer-readable medium of clause 175, wherein the stored instructions further cause the at least one processor to inject the priority tag into a HyperText Markup Language (HTML) data file for the webpage.

Clause 177. An apparatus comprising: a hint procurement circuit structured to interpret hint data defining a plurality of hints structured to facilitate loading of a webpage; a combination circuit structured to generate a plurality of hint combinations from the plurality of hints; an auto-tuning circuit structured to: load, for each of the plurality of hint combinations, the webpage using the hint combination; determine, for each loading of the webpage, a timing for an event associated with the loading for the webpage; and select a hint combination from the plurality of hint combinations based at least in part on the timings; and a recommendation provisioning circuit structured to transmit the selected hint combination.

Clause 178. The apparatus of clause 177, wherein the auto-tuning circuit is further structured to generate the plurality of hint combinations based at least in part on an expected network resource associated with the plurality of hints.

Clause 179. The apparatus of clause 178, wherein the expected network resource is based at least in part on at least one of: a bandwidth, a latency, or a cost.

Clause 180. The apparatus of clause 177, wherein the auto-tuning circuit is further structured to generate the plurality of hint combinations based at least in part on an expected compute resource associated with the plurality of hints.

Clause 181. The apparatus of clause 180, wherein the expected compute resource is based at least in part on at least one of: a cache; or a processing capability.

Clause 182. A method comprising: interpreting, via a hint procurement circuit, hint data defining a plurality of hints structured to facilitate loading of a webpage; generating, via a combination circuit, a plurality of hint combinations from the plurality of hints; loading, for each of the plurality of hint combinations and via an auto-tuning circuit, the webpage using the hint combination; determining, for each loading of the webpage and via the auto-tuning circuit, a timing for an event associated with the loading for the webpage; selecting, via the auto-tuning circuit, a hint combination from the plurality of hint combinations based at least in part on the timings; and transmitting, via a recommendation provisioning circuit, the selected hint combination.

Clause 183. The method of clause 182, generating the plurality of hint combinations is based at least in part on an expected network resource associated with the plurality of hints.

Clause 184. The method of clause 183, wherein the expected network resource is based at least in part on at least one of: a bandwidth, a latency, or a cost.

Clause 185. The method of clause 182, wherein generating the plurality of hint combinations is based at least in part on an expected compute resource associated with the plurality of hints.

Clause 186. The method of clause 185, wherein the expected compute resource is based at least in part on at least one of: a cache; or a processing capability.

Clause 187. A non-transitory computer-readable medium storing instructions that, when loaded into at least one processors, cause the at least one processor to: interpret hint data defining a plurality of hints structured to facilitate loading of a webpage; generate a plurality of hint combinations from the plurality of hints; load, for each of the plurality of hint combinations, the webpage using the hint combination; determine, for each loading of the webpage, a timing for an event associated with the loading for the webpage; select a hint combination from the plurality of hint combinations based at least in part on the timings; and transmit the selected hint combination.

Clause 188. The non-transitory computer-readable medium of clause 187, wherein the stored instructions further cause the at least one processor to generate the plurality of hint combinations based at least in part on an expected network resource associated with the plurality of hints.

Clause 189. The non-transitory computer-readable medium of clause 188, wherein the expected network resource is based at least in part on at least one of: a bandwidth, a latency, or a cost.

Clause 190. The non-transitory computer-readable medium of clause 187, wherein the stored instructions are further structured to generate the plurality of hint combinations based at least in part on an expected compute resource associated with the plurality of hints.

Clause 191. The non-transitory computer-readable medium of clause 190, wherein the expected compute resource is based at least in part on at least one of: a cache; or a processing capability.

Clause 192. An apparatus comprising: a resource procurement circuit structured to interpret a set of resources for a webpage; a resource identifier circuit structured to select a first subset of resources from the set of resources; a resource provisioning circuit structured to transmit the set of resources to a webpage browser, wherein the first subset of resources is transmitted to the webpage browser after a first delay; a resource monitoring circuit structured to: monitor a first execution of the webpage browser that uses the set of resources to load the webpage, and determine a first timing of an event during the first execution; a resource analysis circuit structured to determine, based at least in part on the first timing and the first delay, one or more blocking resources, in the set of resources, for the event; a hint procurement circuit structured to interpret hint data defining a plurality of hints structured to facilitate prefetching of the one or more blocking resources as part of loading of the webpage; a combination circuit structured to generate a plurality of hint combinations from the plurality of hints; an auto-tuning circuit structured to: load, for each of the plurality of hint combinations, the webpage using the webpage browser and the hint combination; determine, for each loading of the webpage, a timing for an event associated with the loading for the webpage; generate, based at least in part on the timings, performance data for the plurality of hint combinations; and select a hint combination from the plurality of hint combinations based at least in part on the timings; and a recommendation provisioning circuit structured to transmit the selected hint combination.

Clause 193. The apparatus of clause 192 further comprising: the webpage browser, wherein the webpage browser is structured to: interpret the selected hint combination; and load the webpage using the selected hint combination.

Clause 194. The apparatus of clause 192 further comprising: a memory device; and a collection circuit structured to: collect the set of resources; and store the set of resources in the memory device; and the resource procurement circuit is further structured to retrieve the set of resources from the memory device.

Clause 195. The apparatus of clause 192, wherein the event is a largest contentful paint.

Clause 196. The apparatus of clause 192, wherein the event is an all contentful paint.

Clause 197. The apparatus of clause 192, wherein the event is a paint event.

Clause 198. The apparatus of clause 192, wherein the event is a first contentful object paint.

Clause 199. The apparatus of clause 192, wherein the event is a visual complete.

Clause 200. The apparatus of clause 192, wherein the event is update layout tree.

Clause 201. The apparatus of clause 192, wherein the event is a snappi-event.

Clause 202. The apparatus of clause 201 further comprising: a snappiness circuit structured to identify the snappi-event by analyzing a second execution of the webpage browser that uses the set of resources to load the webpage.

Clause 203. A method comprising: interpreting, via a resource procurement circuit, a set of resources for a webpage; selecting, via a resource identifier circuit, a first subset of resources from the set of resources; transmitting, via a resource provisioning circuit, the set of resources to a webpage browser, wherein the first subset of resources is transmitted to the webpage browser after a first delay; monitoring, via a resource monitoring circuit, a first execution of the webpage browser that uses the set of resources to load the webpage; determining, via the resource monitoring circuit, a first timing of an event during the first execution; determining, via a resource analysis circuit and based at least in part on the first timing and the first delay, one or more blocking resources, in the set of resources, for the event; interpreting, via hint procurement circuit, hint data defining a plurality of hints structured to facilitate prefetching of the one or more blocking resources as part of loading of the webpage; generating, via a combination circuit, a plurality of hint combinations from the plurality of hints; loading, for each of the plurality of hint combinations via an auto-tuning circuit, the webpage using the webpage browser and the hint combination; determining, for each loading of the webpage via the via an auto-tuning circuit, a timing for an event associated with the loading for the webpage; generating, via the auto-tuning circuit and based at least in part on the timings, performance data for the plurality of hint combinations; selecting, via the via an auto-tuning circuit, a hint combination from the plurality of hint combinations based at least in part on the timings; and transmitting, via a recommendation provisioning circuit, the selected hint combination.

Clause 204. The method of clause 203 further comprising: interpreting, via a webpage browser, the selected hint combination; and loading, via the webpage browser, the webpage using the selected hint combination.

Clause 205. The method of clause 203 further comprising: collecting, via a collection circuit, the set of resources; storing, via the collection circuit, the set of resources in a memory device; and retrieving, via the resource procurement circuit, the set of resources from the memory device.

Clause 206. The method of clause 203, wherein the event is a largest contentful paint.

Clause 207. The method of clause 203, wherein the event is an all contentful paint.

Clause 208. The method of clause 203, wherein the event is a paint event.

Clause 209. The method of clause 203, wherein the event is a first contentful object paint.

Clause 210. The method of clause 203, wherein the event is a visual complete.

Clause 211. The method of clause 203, wherein the event is update layout tree.

Clause 212. The method of clause 203, wherein the event is a snappi-event.

Clause 213. The method of clause 212 further comprising: analyzing, via a snappiness circuit, a second execution of the webpage browser that uses the set of resources to load the webpage; and identifying, via the snappiness circuit, the snappi-event in response to the analysis of the second execution of the webpage browser.

Clause 214. A non-transitory computer-readable medium storing instructions that, when loaded into at least one processor, causes the at least one processor to: interpret a set of resources for a webpage; select a first subset of resources from the set of resources; transmit the set of resources to a webpage browser, wherein the first subset of resources is transmitted to the webpage browser after a first delay; monitor a first execution of the webpage browser that uses the set of resources to load the webpage; determine a first timing of an event during the first execution; determine, based at least in part on the first timing and the first delay, one or more blocking resources, in the set of resources, for the event; interpret hint data defining a plurality of hints structured to facilitate prefetching of the one or more blocking resources as part of loading of the webpage; generate a plurality of hint combinations from the plurality of hints; load, for each of the plurality of hint combinations, the webpage using the webpage browser and the hint combination; determine, for each loading of the webpage, a timing for an event associated with the loading for the webpage; generate, based at least in part on the timings, performance data for the plurality of hint combinations; select a hint combination from the plurality of hint combinations based at least in part on the timings; and transmit the selected hint combination.

Clause 215. The non-transitory computer-readable medium of clause 214, wherein the stored instructions further adapt the at least one processor to: collect the set of resources; store the set of resources in a memory device; and retrieve the set of resources from the memory device.

Clause 216. The non-transitory computer-readable medium of clause 214, wherein the event is a largest contentful paint.

Clause 217. The non-transitory computer-readable medium of clause 214, wherein the event is an all contentful paint.

Clause 218. The non-transitory computer-readable medium of clause 214, wherein the event is a first contentful object paint.

Clause 219. The non-transitory computer-readable medium of clause 214, wherein the event is a visual complete.

Clause 220. The non-transitory computer-readable medium of clause 214, wherein the event is update layout tree.

Clause 221. The non-transitory computer-readable medium of clause 214, wherein the event is a snappi-event.

Clause 222. The non-transitory computer-readable medium of clause 221, wherein the stored instructions further adapt the at least one processor to: identify the snappi-event by analyzing a second execution of the webpage browser that uses the set of resources to load the webpage.

Clause 223. A system comprising: a snappi-event identifier circuit structured to interpret a set of resources for a webpage and determine one or more blocking resources; a hint conducting circuit structured to: interpret data defining a plurality of hints structured to facilitate prefetching of the one or more blocking resources as part of loading webpage; and generate a recommended hint set for one or more of the plurality of hints; and a recommendation provisioning circuit structured to transmit the recommended hint set.

Clause 224. The system of clause 223, wherein the snappi-event identifier circuit is further structured to: execute a plurality of loadings of the webpage; and determine, based at least in part on the plurality of loadings of the webpage, a snappi-event; wherein the one or more blocking resources are associated with the snappi-event.

Clause 225. The system of clause 224, wherein the snappi-event corresponds to a display of a main-content portion of the webpage.

Clause 226. The system of clause 224, wherein the hint conducting circuit is further structured to: generate distinct combinations of the plurality of hints; load, for each of the distinct combinations, the webpage using the distinct combination; and determine a fastest distinct combination that has a lowest time to completion for the snappi-event; wherein the recommended hint set is based at least in part on the fastest distinct combination.

Clause 227. The system of clause 226, wherein the hint conducting circuit is further structured to generate the distinct hint combinations based at least in part on network resources associated with the set of resources.

Clause 228. The system of clause 226, wherein the hint conducting circuit is further structured to generate the distinct hint combinations based at least in part on computing resources associated with the set of resources.

Clause 229. The system of clause 223 further comprising: a webpage browser structured to load the webpage using the recommended hint set.

Clause 230. A method comprising: interpreting, via a snappi-event identifier circuit, a set of resources for a webpage; determining, via the snappi-event identifier circuit, one or more blocking resources; interpreting, via a hint conducting circuit, data defining a plurality of hints structured to facilitate prefetching of the one or more blocking resources as part of loading webpage; generating, via the hint conducting circuit, a recommended hint set for one or more of the plurality of hints; and transmitting, via a recommendation provisioning circuit, the recommended hint set.

Clause 231. The method of clause 230 further comprising: executing, via the snappi-event identifier circuit, a plurality of loadings of the webpage; and determining, via the snappi-event identifier circuit and based at least in part on the plurality of loadings of the webpage, a snappi-event; wherein the one or more blocking resources are associated with the snappi-event.

Clause 232. The method of clause 231, wherein the snappi-event corresponds to a display of a main-content portion of the webpage.

Clause 233. The method of clause 231 further comprising: generating, via the hint conducting circuit, distinct combinations of the plurality of hints; loading, for each of the distinct combinations via the hint conducting circuit, the webpage using the distinct combination; and determining, via the hint conducting circuit, a fastest distinct combination that has a lowest time to completion for the snappi-event; wherein the recommended hint set is based at least in part on the fastest distinct combination.

Clause 234. The method of clause 233, wherein generating, via the hint conducting circuit, the distinct hint combinations is based at least in part on network resources associated with the set of resources.

Clause 235. The method of clause 233, wherein generating, via the hint conducting circuit, the distinct hint combinations is based at least in part on computing resources associated with the set of resources.

Clause 236. The method of clause 230 further comprising: loading a webpage browser using the recommended hint set.

Clause 237. A non-transitory computer-readable medium storing instructions that, when loaded into at least one processor, cause the at least one processor to: interpret a set of resources for a webpage and determine one or more blocking resources; interpret data defining a plurality of hints structured to facilitate prefetching of the one or more blocking resources as part of loading webpage; generate a recommended hint set for one or more of the plurality of hints; and transmit the recommended hint set.

Clause 238. The non-transitory computer-readable medium of clause 237, wherein the stored instructions further cause the at least one processor to: execute a plurality of loadings of the webpage; and determine, based at least in part on the plurality of loadings of the webpage, a snappi-event; wherein the one or more blocking resources are associated with the snappi-event.

Clause 239. The non-transitory computer-readable medium of clause 238, wherein the snappi-event corresponds to a display of a main-content portion of the webpage.

Clause 240. The non-transitory computer-readable medium of clause 238, wherein the stored instructions further cause the at least one processor to: generate distinct combinations of the plurality of hints; load, for each of the distinct combinations, the webpage using the distinct combination; and determine a fastest distinct combination that has a lowest time to completion for the snappi-event; wherein the recommended hint set is based at least in part on the fastest distinct combination.

Clause 241. The non-transitory computer-readable medium of clause 240, wherein the distinct hint combinations are generated based at least in part on network resources associated with the set of resources.

Clause 242. The non-transitory computer-readable medium of clause 240, wherein the distinct hint combinations are generated based at least in part on computing resources associated with the set of resources.

Clause 243. The non-transitory computer-readable medium of clause 237, wherein the stored instructions further cause the at least one processor to: collect the set of resources; store the set of resources in a memory device; and retrieve the set of resources from the memory device.

Clause 244. A method comprising: visiting a webpage with a web browser; observing a first timing of a page event for the webpage; recording a superset of resources fetched as part of a rendering of the webpage occurring prior to the page event; visiting the webpage a second time with a web browser that introduces a delay prior to the fetching of one of the superset of resources, wherein the delay is of an amount that is greater than the timing of the page event; observing a second timing of the page event after the delay; and determining, based in part on the second timing and the amount of the delay, that the one of the superset of resources is blocking for the page event.

Clause 245. The method of clause 244, wherein the first timing is indicative of a human-person sense of page speed for the webpage.

Clause 246. The method of clause 244, wherein the delay is at least two times greater than the timing of the page event.

Clause 247. The method of clause 244, wherein the page event is a largest contentful paint.

Clause 248. The method of clause 244, wherein the page event is an all contentful paint.

Clause 249. The method of clause 244, wherein the page event is a paint event.

Clause 250. The method of clause 244, wherein the page event is a first contentful object paint.

Clause 251. The method of clause 244, wherein the page event is a visual complete.

Clause 252. The method of clause 244, wherein the page event is update layout tree.

Clause 253. The method of clause 244, wherein the page event is a snappi-event.

Clause 254. The method of clause 244, wherein the one of the superset of resources is required for the page event to complete.

Clause 255. The method of clause 244 further comprising: monitoring a CPU on which at least part of the web browser executes; wherein determining, based in part on the second timing and the amount of the delay, that the one of the superset of resources is blocking for the page event comprises: determining that the one of the superset of resources blocks execution of the web browser on the CPU.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly. In embodiments, a circuit may be implemented in hardware, software, and/or a combination thereof. For example, a circuit may include software executing on a general-purpose digital processing system, a general-purpose computer, electronic circuitry, and/or any combination thereof. In embodiments, a circuit may include a single computing machine and/or be distributed across multiple computing machines.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves include a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware, computers, computing devices, processors, circuits, and/or servers include, without limitation, a general-purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions, and the like. The processor may be or include a signal processor, digital processor, embedded processor, microprocessor, or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions, and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server, and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client, and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM, and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer-readable instructions described above. All such permutations and combinations are contemplated in embodiments of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

What is claimed is:

1. A method comprising:
interpreting a set of resources;
selecting a first subset of resources from the set of resources;
transmitting the set of resources to an application, wherein the first subset of resources is transmitted to the application after a first delay;
monitoring a first execution of the application that uses the set of resources;
determining a first timing of an event during the first execution;
determining, based at least in part on the first timing and the first delay, one or more blocking resources, in the set of resources, for the event; and
transmitting a message comprising an indicator that identifies the one or more blocking resources.

2. The method of claim 1, wherein the application is a webpage browser.

3. The method of claim 2, wherein:
the set of resources are for a webpage; and
the method further comprises:
collecting the set of resources for the webpage;
storing the set of resources and the webpage in a memory device; and
retrieving the set of resources from the memory device.

4. The method of claim 1, wherein the event is a snappi-event.

5. The method of claim 4 further comprising:
identifying the snappi-event by analyzing a second execution of the application using the set of resources.

6. The method of claim 1, wherein the one or more blocking resources are required for the event to complete.

7. The method of claim 1 further comprising:
interpreting a timing baseline for the event;
wherein, determining the one or more blocking resources is further based at least in part on the timing baseline.

8. The method of claim 7, wherein determining the one or more blocking resources is further based at least in part on the first timing being longer than an expected timing for the event defined by the timing baseline.

9. The method of claim 1 further comprising:
monitoring a CPU on which at least part of the first execution of the application occurs; and
determining that at least one of the first subset of resources blocks the at least a part of the first execution on the CPU;
wherein determining the one or more blocking resources is based at least in part on the determination that the at least one of the first subset of resources blocks at least a part of the first execution on the CPU.

10. The method of claim 1 further comprising:
selecting a second subset of resources from the set of resources;
re-transmitting the set of resources to the application, wherein the second subset of resources is re-transmitted to the application after a second delay;
monitoring a second execution of the application using the set of resources; and
determining a second timing of the event during the second execution;
wherein determining the one or more blocking resources is further based at least in part on the second timing and the second delay.

11. The method of claim 10, wherein the one or more blocking resources includes resources in the first subset of resources and the second subset of resources.

12. The method of claim 10 further comprising:
comparing the first timing to the second timing, wherein:
the one or more blocking resources includes resources in the first subset of resources when the first timing is longer than the second timing; and
the one or more blocking resources includes resources in the second subset of resources when the second timing is longer than the first timing.

13. The method of claim 1, wherein the monitoring the first execution of the application comprises receiving information regarding the first execution from the application.

14. The method of claim 1 further comprising generating a plurality of hints for the one or more blocking resources.

15. The method of claim 14, further comprising:
generating a plurality of hint combinations from the plurality of hints;
loading, for each of the plurality of hint combinations, the application using the hint combination;
determining, for each loading of the application, a third timing for the event;
generating, based at least in part on the third timings, performance data for the plurality of hint combinations; and
transmitting the performance data.

16. The method of claim 15, further comprising generating a second plurality of hints based on the performance data.

17. An apparatus comprising:
at least one processor; and
at least one memory device storing an application that, when loaded into the at least one processor, causes the at least one processor to:
interpret a set of resources;
select a first subset of resources from the set of resources;
transmit the set of resources to the application, wherein the first subset of resources is transmitted to the application after a first delay;
monitor a first execution of the application that uses the set of resources;
determine a first timing of an event during the first execution;
determine, based at least in part on the first timing and the first delay, one or more blocking resources, in the set of resources, for the event; and
transmit a message comprising an indicator that identifies the one or more blocking resources.

18. The apparatus of claim 17, wherein the application is a webpage browser.

19. The apparatus of claim 18, wherein:
the set of resources are for a webpage; and
wherein the application that, when loaded into the at least one processor, further causes the at least one processor to:
collect the set of resources for the webpage;
store the set of resources and the webpage in a memory device; and
retrieve the set of resources from the memory device.

20. The apparatus of claim 17, wherein the event is a snappi-event.

21. The apparatus of claim 20, wherein the application that, when loaded into the at least one processor, further causes the at least one processor to:
identify the snappi-event by analyzing a second execution of the application using the set of resources.

22. The apparatus of claim 17, wherein the one or more blocking resources are required for the event to complete.

23. The apparatus of claim 17, wherein the application that, when loaded into the at least one processor, further causes the at least one processor to:
interpret a timing baseline for the event;
wherein, determining the one or more blocking resources is further based at least in part on the timing baseline.

24. The apparatus of claim 23, wherein determining the one or more blocking resources is further based at least in part on the first timing being longer than an expected timing for the event defined by the timing baseline.

25. The apparatus of claim 17, wherein the application that, when loaded into the at least one processor, further causes the at least one processor to:
monitor a CPU on which at least part of the first execution of the application occurs; and
determine that at least one of the first subset of resources blocks the at least a part of the first execution on the CPU;
wherein determining the one or more blocking resources is based at least in part on the determination that the at least one of the first subset of resources blocks at least a part of the first execution on the CPU.

26. The apparatus of claim 17, wherein the application that, when loaded into the at least one processor, further causes the at least one processor to:
select a second subset of resources from the set of resources;
re-transmit the set of resources to the application, wherein the second subset of resources is re-transmitted to the application after a second delay;
monitor a second execution of the application using the set of resources; and
determine a second timing of the event during the second execution;
wherein determining the one or more blocking resources is further based at least in part on the second timing and the second delay.

27. The apparatus of claim 26, wherein the one or more blocking resources includes resources in the first subset of resources and the second subset of resources.

28. The apparatus of claim 26, wherein the application that, when loaded into the at least one processor, further causes the at least one processor to:
compare the first timing to the second timing, wherein:
the one or more blocking resources includes resources in the first subset of resources when the first timing is longer than the second timing; and
the one or more blocking resources includes resources in the second subset of resources when the second timing is longer than the first timing.

29. The apparatus of claim 17, wherein the monitoring the first execution of the application comprises receiving information regarding the first execution from the application.

30. The apparatus of claim 17, wherein the application that, when loaded into the at least one processor, further causes the at least one processor to:
generate a plurality of hints for the one or more blocking resources;
generate a plurality of hint combinations from the plurality of hints;
load, for each of the plurality of hint combinations, the application using the hint combination;
determine, for each loading of the application, a third timing for the event;
generate, based at least in part on the third timings, performance data for the plurality of hint combinations; and
generate a second plurality of hints based on the performance data.
